(19) United States
(12) Patent Application Publication
(10) Pub. No.: US 2015/0032572 A1
(43) Pub. Date: Jan. 29, 2015

(54) APPARATUS AND METHOD FOR FACILITATING ON-LINE TRANSACTIONS AND/OR ELECTRONIC COMMERCE TRANSACTIONS

(71) Applicants: MARY ANTONETTE SPANO a/k/a CALVI, YONKERS, NY (US); RAYMOND ANTHONY JOAO, YONKERS, NY (US)

(72) Inventors: MARY ANTONETTE SPANO a/k/a CALVI, YONKERS, NY (US); RAYMOND ANTHONY JOAO, YONKERS, NY (US)

(21) Appl. No.: 14/308,285

(22) Filed: Jun. 18, 2014

Related U.S. Application Data
(60) Provisional application No. 61/958,389, filed on Jul. 26, 2013.

(51) Int. Cl. G06Q 30/06

(52) U.S. Cl. CPC G06Q 30/0623
USPC 705/26.61

(57) ABSTRACT

A computer-implemented method, including receiving, with a receiver, a processing device, or a computer, a request from a user for information regarding a selected merchandise group regarding any type or kind of good, product, or item of merchandise, offered for sale by a merchant in a brick and mortar store of the merchant, processing information regarding the request with or using the processing device or the computer, and transmitting, from a transmitter, the processing device, or the computer, a merchandise group shopping page to a communication device used by the user in response to the request. The merchandise group shopping page contains at least one photograph, at least one picture, at least one video, or at least one video image, of the merchant's brick and mortar store offering, assortment, or arrangement, of goods, products, or items of merchandise, in the selected merchandise group.

### RELATED APPLICATIONS

This application claims the benefit of the priority of U.S. Provisional Patent Application Ser. No. 61/958,389, filed Jul. 26, 2013, and entitled “APPARATUS AND METHOD FOR FACILITATING ON-LINE TRANSACTIONS AND/OR ELECTRONIC COMMERCE TRANSACTIONS”, the subject matter and teachings of which are hereby incorporated by reference herein in their entirety.

### FIELD OF THE INVENTION

The present invention pertains to an apparatus and method for facilitating on-line transactions and/or electronic commerce transactions and, in particular, to an apparatus and method for facilitating on-line transactions and/or electronic commerce transactions which can allow a consumer or individual to engage in on-line shopping and/or electronic commerce shopping from, using, or while viewing, photographs, pictures, or video images, of actual in-store stocks, arrangements, and/or presentations, of goods, products, or merchandise, in a merchant's store or retail facility or so-called “brick and mortar store”.

### BACKGROUND OF THE INVENTION

Millions of consumers enjoy the ease and convenience which accompany shopping on-line and/or via the Internet and/or the World Wide Web. As compared to shopping in conventional or traditional stores or retail facilities, such as the so-called “brick and mortar stores”, businesses, buildings, or facilities, which provide a physical building or a physical premises within which, or on which, an individual or consumer can shop and is able to physically handle goods, products, or merchandise, and interact face-to-face with merchants or their employees or agents, individuals or consumers can save a great deal of time and expense by simply shopping with or via a home or personal computer, a laptop computer, a tablet computer or tablet, or with or via a cellular telephone or personal digital assistant.

While convenient, shopping on-line and/or via the Internet and/or the World Wide Web, does have a number of drawbacks and disadvantages. Typically, one must navigate through a number of web pages of goods, products, merchandise, or articles, with some web pages only showing one such good, product, merchandise, or article, at a time, in order to obtain and/or ascertain the available offerings from which a selection can be made.

In addition, on-line or Internet shoppers are not provided with a realistic presentation of the goods, products, or merchandize, that are actually offered and/or presented in a so-called “brick and mortar store”. Lastly, on-line or Internet shoppers are not able or view all goods, products, or merchandise, offered in a real-life manner and/or in an easy or quick manner, but rather, are typically provided with offered goods, products, or merchandise, in a piecemeal fashion.

### SUMMARY OF THE INVENTION

The present invention pertains to an apparatus and method for facilitating on-line transactions and/or electronic commerce transactions which overcomes the shortcomings of the prior art. In particular, the present invention pertains to an apparatus and method for facilitating on-line transactions and/or electronic commerce transactions which can allow a consumer or individual to engage in on-line shopping and/or electronic commerce shopping from, using, or while viewing, photographs, pictures, or video images, of actual in-store stocks, arrangements, and/or presentations, of goods, products, or merchandise, in a merchant's store or retail facility or so-called “brick and mortar store”.

The present invention provides an apparatus and method for allowing a consumer or individual to shop at any brick and mortar store while on-line and/or while using the Internet and/or the World Wide Web by shopping from and/or by or while viewing a photograph(s), picture(s), video, video image(s), or a video clip(s) or video footage, of actual in-store stocks, arrangements, displays, or presentations, of goods, products, or merchandise, as they are arranged, situated, and/or displayed, in the brick and mortar store environment of the merchant or the distributor.

The present invention can be utilized in connection with, for example, but not limited to, any goods, products, merchandise, merchandise items or items of merchandise, food, food products, produce, clothing, footwear, consumer goods, consumer electronics, and/or any other goods, products, or merchandise, or services, which can be the subject of commerce and/or which can be offered for sale by, and/or which can be sold by, or provided by, any type or kind of merchants or distributors and/or by any of the various merchants and/or distributors described herein or otherwise.

The apparatus of the present invention includes a central processing computer which can provide control over the apparatus of the present invention and which can perform any and/or all of the various processing routines, processing operations, and/or functionality, described herein as being provided by the present invention. The central processing computer can be any suitable computer, network computer, or computer system, and/or can also be comprised of one or more computers or computer systems, and/or can have a website associated with same so as to enable use of the apparatus and/or the central processing computer on, over, or via, the Internet and/or the World Wide Web. Any given central processing computer can service a single merchant, retail store, retail facility, commercial entity, or business entity, or can service any number of merchants, retail stores, retail facilities, commercial entities, or business entities.

The apparatus of the present invention can also include a server computer which can also perform any of the processing routines and functionality described herein as being performed by the apparatus of the present invention and/or the central processing computer. The server computer can be any server, computer, computer system, group of computers, server system, or group of servers, which can be programmed and/or equipped to perform any of the herein-described functions, operations, or actions, described herein as being performed by the central processing computer and/or the apparatus of the present invention.

The server computer can be connected with, linked to, or linked with, the central processing computer.

The apparatus of the present invention can also include a merchant computer or communication device which can be utilized by any merchant, retail store, retail facility, commercial entity, or business entity, and/or by any group of merchants, retail stores, retail facilities, commercial entities, or business entities, who or which operate a brick and mortar store or facility and who or which conduct on-line, e-commerce, and/or Internet, transactions and/or who or which utilizes the present invention. The merchant computer or communication device can be utilized to communicate with, transmit signals, data, information, or a message, to, receive signals, data, information, or a message, from, or to access, or which can be linked with, or which can be wirelessly linked with, the central processing computer.

The merchant computer or communication device can process information regarding transactions involving the sale of goods, products, merchandise, and/or any articles or items which can be the subject of commerce, and/or any services, can process any data and/or information relating, regarding, or pertaining to, any transactions involving the sale and/or purchase of any goods, products, merchandise, and/or any articles or items which can be the subject of commerce, and/or any services, can process data and/or information for receiving orders, processing orders, fulfilling orders, shipping orders, preparing orders for pick-up, billing regarding orders, transaction processing, payment processing, returns processing, processing information for refunds, and/or can perform any other processing routines or functionality which can typically be expected to be performed by a merchant computer or communication device in an on-line, e-commerce, or Internet, transaction processing environment, as well as any merchant computer or communication device which can be utilized in a brick and mortar store environment.

The apparatus of the present invention can also include a distributor computer or communication device which can be utilized by any distributor, manufacturer, producer, wholesaler, or seller, of any of the goods, products, merchandise, or articles or items, which can be offered for sale or sold via or using the apparatus of the present invention. The distributor computer can be utilized to communicate with, transmit signals, data, information, or a message, to, receive signals, data, information, or a message, from, or to access, or which can be linked with, or which can be wirelessly linked with, any of the central processing computers and/or any of the merchant computers described herein.

The distributor computer or communication device can process information regarding transactions involving the sale of goods, products, merchandise, and/or any articles or items which can be the subject of commerce, and/or any services, can process any data and/or information relating, regarding, or pertaining to, any transactions involving the sale and/or purchase of any goods, products, merchandise, and/or any articles or items which can be the subject of commerce, and/or any services, can process data and/or information for receiving orders, processing orders, fulfilling orders, shipping orders, preparing orders for pick-up, billing regarding orders, transaction processing, payment processing, returns processing, processing information for refunds, and/or can for perform any other processing routines or functionality which can typically be expected to be performed by a distributor computer or communication device in an on-line, e-commerce, or Internet, transaction processing environment, as well as any distributor computer or communication device which can be utilized in a brick and mortar store environment.

The distributor computer or communication device can be connected with, linked to, wirelessly connected with, or wirelessly linked to or with, the central processing computer and/or the distributor computer or communication device can be connected with, linked to, wirelessly connected with, or wirelessly linked to or with, any merchant computer or communication device.

The apparatus of the present invention can also include a communication device which can be utilized by any user or individual who or which utilizes the apparatus of the present invention. The communication device can be utilized to communicate with, transmit signals, data, information, or a message, to, receive signals, data, information, or a message, from, or to access, or which can be linked with, or which can be wirelessly linked with, any of the central processing computers, server computers, merchant computer or communication devices, and/or distributor computers or communication devices described herein.

The communication device can be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, Internet-enabled eyewear or glasses, Internet-enabled clothing or articles of clothing or footwear, Internet-enabled accessories, Internet-enabled jewelry and time pieces, a telephone, a television, an interactive television, a digital television, a smart television or entertainment device, an internet-enabled television or entertainment device, or any other suitable device, which can be equipped to perform the functions described herein as being performed by the communication device.

Each of the respective central processing(s), server computer(s), merchant computer or communication device(s), distributor computer or communication device(s), and communication devices can include, or can be equipped with a central processing unit (CPU), a random access memory (RAM), a read only memory (ROM), any of the input devices described herein, any of the output devices described herein, a display device, a transmitter(s), a receiver(s), a database(s), a global positioning system (GPS) device, a camera, a video recording device, a microphone, or an audio recording device, and/or any other hardware, software, and/or devices, described herein.

The present invention can be utilized on, and/or over, the Internet and/or the World Wide Web, and/or any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

Each of the central processing computer(s), the server computer(s), the merchant computers or communication devices, the distributor computers or communication devices, and/or the communication device(s), can be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any central processing computer(s), server computer(s), merchant computers or communication device, distributor computer or communication device, and/or communication device. Any central processing computer, server computer, merchant computer of communication device, or distributor computer or communication device, can have a web site or web sites associated therewith.

The present invention can be utilized in a number of preferred embodiments in order to allow any of the herein-described users to engage in on-line shopping and/or Internet shopping with any of the herein-described merchants and/or distributors. The apparatus of the present invention can be utilized in order to shop on-line and/or via the Internet by viewing actual in-store pictures, photographs, video, video clips, or video footage, of the various goods, products, or merchandise, offered by a merchant and/or a distributor, as same are arranged, displayed, situated, or presented, in or on store aisles, store shelves, store racks, display stands, display racks, showcases, wall displays, point-of-sale displays, or any other type or kind of display, arrangement, or presentation, of any of the goods, products, or merchandise offered for sale by, or sold by, the respective merchant or distributor.

Any number of pictures, photographs, or other video images, or other visual depictions, can be photographed or recorded, and/or stored, and/or be can be linked together, for any and/or all or each type, kind, groups, or classification, of any goods, products, or merchandise, offered for sale by, or sold by, the respective merchant or distributor.

Any of the data and/or information described herein as being utilized, stored, provided by, and/or processed by, any central processing computer, server computer, merchant computer or communication device, distributor computer or communication device, or communication device, can be updated at any time and/or automatically.

The present invention can be utilized in connection with on-line shopping and/or Internet shopping for or involving any good(s), product(s), or merchandise, or any service(s), which can be offered for sale by, or sold by, any of the various types or kinds of merchants and/or distributors described herein, and/or in connection with on-line shopping and/or Internet shopping for or involving any good(s), product(s), or merchandise, or any service(s), which can be the subject of commerce. The present invention can also be utilized by a user in order to shop on-line and/or via the Internet with two or more merchants in or during a single shopping event.

The present invention can also be utilized in a same, a similar, and/or an analogous, manner in order to facilitate or to allow a user to shop on-line and/or via the Internet with any of the herein-described distributors in the distributor's brick and mortar store and/or with the distributor's on-line store.

The present invention can be utilized in a number of preferred embodiments in order to allow any of the herein-described users to engage in on-line shopping and/or Internet shopping with any of the herein-described merchants and/or distributors. The apparatus of the present invention can be utilized in order to shop on-line and/or via the Internet by viewing actual in-store pictures, photographs, video, video clips, or video footage, of the various goods, products, or merchandise, offered by a merchant and/or a distributor, as same are arranged, displayed, situated, or presented, in or on store aisles, store shelves, store racks, display stands, display racks, showcases, wall displays, point-of-sale displays, or any other type or kind of display, arrangement, or presentation, of any of the goods, products, or merchandise offered for sale by, or sold by, the respective merchant or distributor.

Any number of pictures, photographs, or other video images, or other visual depictions, can be photographed or recorded, and/or stored, and/or be can be linked together, for any and/or all or each type, kind, groups, or classification, of any goods, products, or merchandise, offered for sale by, or sold by, the respective merchant or distributor.

Any of the data and/or information described herein as being utilized, stored, provided by, and/or processed by, any central processing computer, server computer, merchant computer or communication device, distributor computer or communication device, or communication device, can be updated at any time and/or automatically.

The present invention can be utilized in connection with on-line shopping and/or Internet shopping for or involving any good(s), product(s), or merchandise, or any service(s), which can be offered for sale by, or sold by, any of the various types or kinds of merchants and/or distributors described herein, and/or in connection with on-line shopping and/or Internet shopping for or involving any good(s), product(s), or merchandise, or any service(s), which can be the subject of commerce. The present invention can also be utilized by a user in order to shop on-line and/or via the Internet with two or more merchants in or during a single shopping event.

The present invention can also be utilized in a same, a similar, and/or an analogous, manner in order to facilitate or to allow a user to shop on-line and/or via the Internet with any of the herein-described distributors in the distributor's brick and mortar store and/or with the distributor's on-line store.

A user can also access a merchant computer or communication device either directly via a communication network and/or via the central processing computer and can engage in on-line shopping and/or Internet shopping directly with the merchant. A user can also access the distributor computer or communication device either directly via a communication network and/or via the central processing computer and can engage in on-line shopping and/or Internet shopping directly with the distributor.

The present invention can be utilized in connection with or in conjunction with any infomercial and/or any live or pre-recorded video presentation of a good(s), product(s), or item(s) of merchandise, an introduction of a good(s), product(s), or item(s) of merchandise, a show, or a fashion show, or any other activity, whether live or recorded (hereinafter “video presentation”), which can be utilized to showcase and/or offer for same, any good(s), product(s), or item(s) of merchandise.

The apparatus of the present invention can be utilized in order to provide electronic coupon accounts for any of the merchants, distributors, and users, described herein, and/or for any operator(s) of any of the herein-described central processing computers.

The apparatus of the present invention can be utilized to automatically establish an account or a relationship or any type or kind of marketing relationship and/or direct marketing relationship between a user and any distributor of and/or to any merchant. The apparatus of the present invention can process information for creating or establishing an account or a relationship between a user and a distributor any time a user browses, places in his or her shopping cart or electronic shopping cart, or purchases, any good(s), product(s), or merchandise, of or provided by the distributor.

The apparatus of the present invention can also transmit or provide any number, type, or kind of alert messages or notification messages to a user. Any user of the present invention can request to receive alerts, alert messages, notifications, notification messages, coupon alerts, sales alerts, availability alerts, delivery alerts, order alerts, reorder alerts, new products alerts, and/or new services alerts, and/or any other alerts or notifications, which can be provided by the apparatus of the present invention, from the central processing computer and/or from any merchant computer or communication device and/or distributor computer or communication device.

In a preferred embodiment, any of the various herein-described alerts, alert messages, notifications, notification messages, coupon alerts, sales alerts, availability alerts, delivery alerts, order alerts, reorder alerts, new products alerts, and/or new services alerts, and/or any other alerts or notifications, can be transmitted as, in, or as an attachment to, an e-mail message, a text message, pre-recorded telephone message, or via any other type, kind, or mode of communication.

The apparatus of the present invention and/or the central processing computer, the merchant computer of communication device, the distributor computer or communication device, or the communication device(s), can be programmed to translate any text information or audio information from one language into another language. When establishing a shopping account with any merchant or distributor, or when establishing an account with the apparatus or the central processing computer, a user can provide information regarding, or can specify, any language or languages in which the user desires to receive any of the text information or audio information, or other information, which the user might desire to obtain or be provided with when using the apparatus of the present invention, or the language or languages in which the user desires to utilize the apparatus of the present invention.

### BRIEF DESCRIPTION OF THE DRAWINGS

In the Drawings:

FIG. 1 illustrates a preferred embodiment of the apparatus of the present invention, in block diagram form;

FIG. 2 illustrates a preferred embodiment of the central processing computer of FIG. 1, in block diagram form;

FIG. 3 illustrates a preferred embodiment of the merchant computer of FIG. 1, in block diagram form;

FIG. 4 illustrates a preferred embodiment of the distributor computer of FIG. 1, in block diagram form;

FIG. 5 illustrates a preferred embodiment of the communication device of FIG. 1, in block diagram form;

FIGS. 6A and 6B illustrate a preferred embodiment method for utilizing the apparatus of the present invention, in flow diagram form; and

FIG. 7 illustrates another preferred embodiment method for utilizing the apparatus of the present invention, in flow diagram form.

### DESCRIPTION OF THE PREFERRED EMBODIMENTS

The present invention pertains to an apparatus and method for facilitating on-line transactions and/or electronic commerce transactions and, in particular, to an apparatus and method for facilitating on-line transactions and/or electronic commerce transactions which can allow a consumer or individual to engage in on-line shopping and/or electronic commerce shopping from, using, or while viewing, photographs, pictures, or video images, of actual in-store stocks, arrangements, and/or presentations, of goods, products, or merchandise, in a merchant's store or retail facility or so-called “brick and mortar store”.

The present invention provides an apparatus and method for allowing a consumer or individual to shop at any brick and mortar store while on-line and/or while using the Internet and/or the World Wide Web by shopping from and/or by or while viewing a photograph(s), picture(s), video, video image(s), or video clip(s) or video footage, of actual in-store stocks, arrangements, displays, or presentations, of goods, products, or merchandise, as they are arranged, situated, and/or displayed, in the brick and mortar store environment of the merchant or the distributor. In this regard, the present invention provides an apparatus and method for allowing a consumer or individual to shop at any brick and mortar store while on-line and/or while using the Internet and/or the World Wide Web by shopping from and/or by viewing or browsing actual in-store stocks, arrangements, displays, or presentations, of goods, products, or merchandise, as they are arranged, situated, and/or displayed, in the brick and mortar store environment of the merchant or the distributor.

As used herein, the term or phrase “brick and mortar store” means, in addition to its usual and customary meaning, as understood by those skilled in the art of the present invention, any physical store, physical structure, physical building, physical retail facility, physical retail business, physical retail store, or any physical premises or physical entity, into which, or onto which, an individual or a consumer may enter and which enables the individual or the consumer to physically handle a good(s), a product(s), or an item(s) of merchandise, physically walk or move around in while shopping, engage in a face-to-face or in person transaction with a merchant or an employee, an agent, or a principal, of same.

As used herein, the term “merchant” as used herein, in addition to its usual and customary meaning, as understood by those skilled in the art of the present invention, also means any merchant, vendor, seller, store, retail store, retail facility, retailer, merchandiser, commercial entity, business entity, or any other entity, or group of same, who or which offers to sell, or sells, goods, products, or merchandise, or any services, in a retail setting or a retail environment. Further, the term “merchant”, as defined that term is defined herein, also means or refers to a food store, food market, supermarket, grocery store, department store, clothing store, footwear store, fashion store or fashion boutique, sporting goods store, dry goods store, hardware store, consumer products store, consumer electronics store, automotive store, automotive goods, products, or merchandise, store, furniture store, home furnishings store, electronics store, hobby store, pet store, pet supplies store, toy store, children's goods, products, or merchandise store, any entity which offers to sell, or sells, goods, products, or services, from a broadcast or transmission of any live event, such as, but not limited to, fashion shows, runway shows, etc., and/or any other brick and mortar store seller of any goods, products, or merchandise, which can be the subject of any commerce.

As used herein, the term “distributor” as used herein, in addition to its usual and customary meaning, as understood by those skilled in the art of the present invention, also means any distributor, wholesaler, manufacturer, producer, or any other business entity or commercial entity who or which offers to sell, or sells, goods, products, or any merchandise, or any services, to any merchants or to any user, individual, or consumer. Further, the term “distributor”, as that term is defined herein, also means or refers to any distributor to any a food store, food market, supermarket, grocery store, department store, clothing store, footwear store, fashion store or fashion boutique, sporting goods store, dry goods store, hardware store, consumer products store, consumer electronics store, automotive store, automotive goods, products, or merchandise store, furniture store, home furnishings store, electronics store, hobby store, pet store, pet supplies store, toy store, children's goods, products, or merchandise store, any entity which offers to sell, or sells, goods, products, or services, from a broadcast or transmission of any live event, such as, but not limited to, fashion shows, runway shows, etc., and/or any other brick and mortar store seller of any goods, products, or merchandise, which can be the subject of any commerce.

Applicant hereby incorporates by reference herein the subject matter and teachings of U.S. Provisional Patent Application Ser. No. 61/958,389, filed Jul. 26, 2013, and entitled “APPARATUS AND METHOD FOR FACILITATING ON-LINE TRANSACTIONS AND/OR ELECTRONIC COMMERCE TRANSACTIONS”, the subject matter and teachings of which are hereby incorporated by reference herein in their entirety.

In a preferred embodiment, the apparatus 100 and method of the present invention can be utilized in connection with, for example, but not limited to, any goods, products, merchandise, merchandise items or items of merchandise, food, food products, produce, clothing, footwear, consumer goods, consumer electronics, and/or any other goods, products, or merchandise, or services, which can be the subject of commerce and/or which can be offered for sale by, and/or which can be sold by, or provided by, any type or kind of merchants or distributors and/or by any of the various merchants and/or distributors described herein or otherwise.

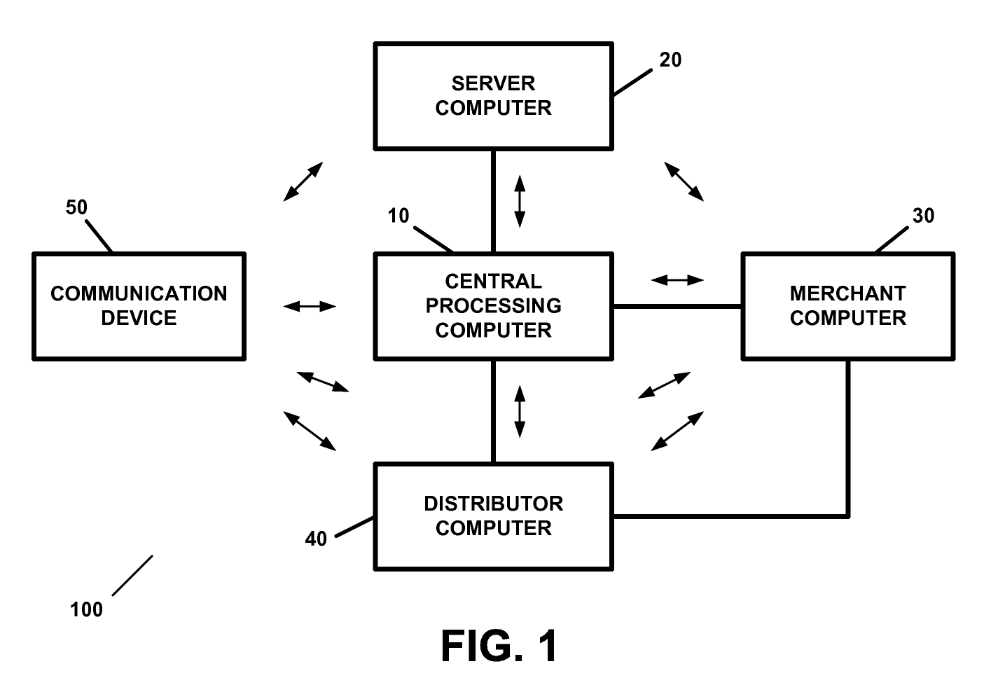

FIG. 1 illustrates a preferred embodiment of the apparatus of the present invention which is denoted generally by the reference numeral 100, in block diagram form. With reference to FIG. 1, the apparatus 100 includes a central processing computer 10. The central processing computer 10 provides control over the apparatus 100 and can perform any and/or all of the various processing routines, processing operations, and/or functionality, described herein as being provided by the apparatus 100. The central processing computer 10 can also perform any of the transaction processing routines described herein as being performed by the apparatus 100 and method of the present invention. The central processing computer 10, in the preferred embodiment, can be any suitable computer, network computer, or computer system. In a preferred embodiment, the central processing computer 10 can also be comprised of one or more computers or computer systems. In a preferred embodiment, the central processing computer 10 can have a website associated with same so as to enable use of the apparatus 100 and/or the central processing computer 10 on, over, or via, the Internet and/or the World Wide Web.

In a preferred embodiment, any number of central processing computers 10 can be utilized in order to provide the servicing functions described herein as being provided by the apparatus 100 of the present invention. The central processing computer(s) 10 may be linked to other central processing computers or may be a stand-alone computer(s) or system(s).

In a preferred embodiment, a given central processing computer 10 can service a single merchant, retail store, retail facility, commercial entity, or business entity, or can service any number of merchants, retail stores, retail facilities, commercial entities, or business entities. In a preferred embodiment, a central processing computer 10 can also be dedicated to servicing a certain type or types of merchants, retail stores, retail facilities, commercial entities, or business entities. For example, a central processing computer 10 can service any number of food stores, grocery stores, supermarkets, clothing stores, sporting goods stores, specialty stores, or any other kind or type of merchants, retail stores, retail facilities, commercial entities, or business entities.

In another preferred embodiment, a single central processing computer 10 can also be adapted to service any one type or any number or combination of types of merchants, retail stores, retail facilities, commercial entities, or business entities.

In a preferred embodiment, the central processing computer 10 can be any computer, computer system, group of computers, server, server system, or group of servers, which can be programmed and/or equipped to perform any of the herein-described functions, operations, or actions, described herein as being performed by the central processing computer 10 and/or the apparatus 100 of the present invention.

In another preferred embodiment, any of the central processing computer(s) 10 described as being utilized in connection or in conjunction with the apparatus 100 and method or the present invention can also be performed by or implemented using cloud computer hardware and/or software. In this regard, any and/or all of the central processing computers 10 described herein can be implemented using a cloud computing architecture, server computers or network computers, and/or any cloud computing hardware and/or software. In this manner, the apparatus 100 of the present invention can be utilized in connection with any number of central processing computer(s) 10 and the apparatus 100 of the present invention can also be utilized in connection with a cloud computing system, network, and/or architecture. Any number, type, or kind, of central processing computer(s) 10 can be utilized in the apparatus 100 of the present invention.

With reference once again to FIG. 1, the apparatus 100 also includes a server computer 20 which can also perform any of the processing routines and functionality described herein as being performed by the apparatus 100 of the present invention and/or the central processing computer 10 or any of the central processing computers 10 described herein as being utilized in the apparatus 100 of the present invention. In a preferred embodiment, the server computer 20 can be any server, computer, computer system, group of computers, server system, or group of servers, which can be programmed and/or equipped to perform any of the herein-described functions, operations, or actions, described herein as being performed by the central processing computer 10 and/or the apparatus 100 of the present invention. Any number of server computers 20 can be utilized in conjunction with the apparatus 100 of the present invention.

In another preferred embodiment, any of the server computer(s) 20 described as being utilized in connection or in conjunction with the apparatus 100 and method or the present invention can also be performed by or implemented using cloud computer hardware and/or software. In this regard, any and/or all of the server computers 20 described herein can be implemented using a cloud computing architecture, server computers or network computers, and/or any cloud computing hardware and/or software. In this manner, the apparatus 100 of the present invention can be utilized in connection with any number of server computers 20 and the apparatus 100 of the present invention can also be utilized in connection with a cloud computing system, network, and/or architecture. Any number, type, or kind, of server computers 20 can be utilized in the apparatus 100 of the present invention.

In a preferred embodiment, the server computer 20 is or can be connected with, linked to, or linked with, the central processing computer 10 and any server computers 20 can be connected with, linked to, or linked with, any central processing computer 10.

With reference once again to FIG. 1, the apparatus 100 also includes a merchant computer or communication device 30 (hereinafter “merchant computer 30”) which can be utilized by any merchant, retail store, retail facility, commercial entity, or business entity, and/or by any group of merchants, retail stores, retail facilities, commercial entities, or business entities, who or which operate a brick and mortar store or facility and who or which conduct on-line, e-commerce, and/or Internet, transactions and/or who or which utilizes the apparatus 100 of the present invention. In a preferred embodiment, the merchant computer 30 can be utilized to communicate with, transmit signals, data, information, or a message, to, receive signals, data, information, or a message, from, or to access, or which can be linked with, or which can be wirelessly linked with, any of the central processing computers 10 described herein.

In a preferred embodiment, the merchant computer 30 can process information regarding transactions involving the sale of goods, products, merchandise, and/or any articles or items which can be the subject of commerce, and/or any services. In this regard, the merchant computer 30 can process any data and/or information relating, regarding, or pertaining to, any transactions involving the sale and/or purchase of any goods, products, merchandise, and/or any articles or items which can be the subject of commerce, and/or any services, as well as processing data and/or information for receiving orders, processing orders, fulfilling orders, shipping orders, preparing orders for pick-up, billing regarding orders, transaction processing, payment processing, returns processing, processing information for refunds, and/or for performing any other processing routines or functionality which can typically be expected to be performed by a merchant computer 30 in an on-line, e-commerce, or Internet, transaction processing environment, as well as any merchant computer 30 which can be utilized in a brick and mortar store environment.

In a preferred embodiment, the merchant computer 30 can be connected with, linked to, wirelessly connected with, or wirelessly linked to or with, the central processing computer 10. In a preferred embodiment, the merchant computer 30 can be any suitable computer or computer system. In a preferred embodiment, the merchant computer 30 can also be, or can include, a personal computer, a laptop computer, a notebook computer, a tablet, a tablet computer, or any other computer or communication device which can be equipped to perform the functions described herein as being performed by the merchant computer 30.

In a preferred embodiment, any number of merchant computers 30 can be assigned to, utilized by, or associated with, any merchant, retail store, retail facility, commercial entity, or business entity, who or which utilizes the apparatus 100 of the present invention.

With reference once again to FIG. 1, the apparatus 100 also includes a distributor computer or communication device 40 (hereinafter “distributor computer 40”) which can be utilized by any distributor, manufacturer, producer, wholesaler, or seller, of any of the goods, products, merchandise, or articles or items, which can be offered for sale or sold via or using the apparatus 100 of the present invention. In a preferred embodiment, the distributor computer 40 can be utilized to communicate with, transmit signals, data, information, or a message, to, receive signals, data, information, or a message, from, or to access, or which can be linked with, or which can be wirelessly linked with, any of the central processing computers 10 and/or any of the merchant computers 30 described herein.

In a preferred embodiment, the distributor computer 40 can process information regarding transactions involving the sale of goods, products, merchandise, and/or any articles or items which can be the subject of commerce, and/or any services. In this regard, the distributor computer 40 can process any data and/or information relating, regarding, or pertaining to, any transactions involving the sale and/or purchase of any goods, products, merchandise, and/or any articles or items which can be the subject of commerce, and/or any services, as well as processing data and/or information for receiving orders, processing orders, fulfilling orders, shipping orders, preparing orders for pick-up, billing regarding orders, transaction processing, payment processing, returns processing, processing information for refunds, and/or for performing any other processing routines or functionality which can typically be expected to be performed by a distributor computer 40 in an on-line, e-commerce, or Internet, transaction processing environment, as well as any distributor computer 40 which can be utilized in a brick and mortar store environment.

In a preferred embodiment, the distributor computer 40 can be connected with, linked to, wirelessly connected with, or wirelessly linked to or with, the central processing computer 10 and/or the distributor computer 40 can be connected with, linked to, wirelessly connected with, or wirelessly linked to or with, any merchant computer 30.

In a preferred embodiment, the distributor computer 40 can be any suitable computer or computer system. In a preferred embodiment, the distributor computer 40 can also be, or can include, a personal computer, a laptop computer, a notebook computer, a tablet, a tablet computer, or any other computer or communication device which can be equipped to perform the functions described herein as being performed by the distributor computer 40.

In a preferred embodiment, any number of distributor computers 40 can be assigned to, utilized by, or associated with, any distributor, manufacturer, producer, wholesaler, or seller, of any of the goods, products, merchandise, or articles or items, which can be offered for sale or sold via or using the apparatus 100 of the present invention, who or which utilizes the apparatus 100 of the present invention.

With reference once again to FIG. 1, the apparatus 100 also includes a communication device 50 which can be utilized by any user or individual who or which utilizes the apparatus 100 of the present invention. In a preferred embodiment, the communication device 50 can be utilized to communicate with, transmit signals, data, information, or a message, to, receive signals, data, information, or a message, from, or to access, or which can be linked with, or which can be wirelessly linked with, any of the central processing computers 10 and/or server computers 20 described herein. In a preferred embodiment, the communication device 50 can also be utilized to communicate with, transmit signals, data, information, or a message, to, receive signals, data, information, or a message, from, or to access, or which can be linked with, or which can be wirelessly linked with, any of the merchant computers 30 and/or distributor computers 40 described herein.

In a preferred embodiment, the communication device 50 can be connected with, linked to, wirelessly connected with, or wirelessly linked to or with, the central processing computer 10 and/or the server computer 20. In a preferred embodiment, the communication device 20 can also be connected with, linked to, wirelessly connected with, or wirelessly linked to or with, the central processing computer 10 and/or the server computer 20 during operation of the apparatus 100 of the present invention as described herein, and/or at any desired time or times.

In a preferred embodiment, the communication device 50 can be connected with, linked to, wirelessly connected with, or wirelessly linked to or with, any merchant computer(s) 30 and/or any distributor computer(s) 40. In a preferred embodiment, the communication device 50 can also be connected with, linked to, wirelessly connected with, or wirelessly linked to or with, any merchant computer(s) 30 and/or any distributor computer(s) 40 during operation of the apparatus 100 of the present invention as described herein, and/or at any desired time or times.

In a preferred embodiment, the communication device 50 can be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, Internet-enabled eyewear or glasses, Internet-enabled clothing or articles of clothing or footwear, Internet-enabled accessories, Internet-enabled jewelry and time pieces, a telephone, a television, an interactive television, a digital television, a smart television or entertainment device, an internet-enabled television or entertainment device, or any other suitable device, which can be equipped to perform the functions described herein as being performed by the communication device 50.

In a preferred embodiment, the communication device 50 can include a central processing unit or device, an input device, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, a retinal scanning device, a fingerprint recognition device, a voice recognition device, a retinal scanner, a fingerprint device, a voice recognition device, a handprint recognition device, a handprint geometry recognition device, a facial feature recognition device, and/or any one or more of the biometric devices used to control access to a computer or a computer network which are known to those skilled in the art at the time of the filing of this patent application, a pointing device, a mouse, an output device, a database or a memory device and/or system, a random access memory (RAM) device, a read only memory (ROM) device, a video recording system or equipment, a camera(s), an audio recording system, device, or equipment, a microphone, a receiver or any number of receivers, a transmitter or any number of transmitters, a network interface device, an information or content gathering device, and/or any other devices, equipments, or systems, typically found in and/or utilized by any of the herein-described communication devices 50 described herein as being utilized in connection with the apparatus 100 of the present invention. In a preferred embodiment, the communication device 50 can also be equipped with a global positioning device which can be utilized to calculate, determine, or ascertain, the position or location of the communication device 50.

In a preferred embodiment, the communication device 50 can also contain, include, or be equipped with, a transmitter(s), a receiver(s), or any other network interface devices or equipment for facilitating bi-directional communication with, and/or data and/or information exchange with, the central processing computer 10 and/or the server computer 20, and/or any of the herein-described merchant computers 30 and/or distributor computers 40.

In a preferred embodiment, the communication device 50 can also include, contain, or be equipped with a camera, a digital video recording system or equipment, a microphone, a digital audio recording system or equipment, or any another digital video and audio recording device or equipment or other digital media recording equipment, that can allow a user or individual to the communication device 50 to take or record a photograph, a picture, a video, a video clip, audio, or an audio clip, for later shopping or other use.

In a preferred embodiment, any number of communication devices 50 can be assigned to, utilized by, or associated with, any user or individual.

In the preferred embodiment, the apparatus 100 of the present invention is utilized on, and/or over, the Internet and/or the World Wide Web. The apparatus 100 of the present invention, in the preferred embodiment, can also utilize wireless Internet and/or World Wide Web services, equipment and/or devices. Although the Internet and/or the World Wide Web is a preferred communication system, network, and/or medium, utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

In a preferred embodiment, each of the central processing computer(s) 10, the server computers 20, the merchant computers 30, the distributor computers 40, and the communication device(s) 50, can be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any central processing computer(s) 10, server computer(s) 20, merchant computer(s) 30, distributor computer(s) 40, and communication device(s) 50.

In a preferred embodiment, each of the central processing computer(s) 10, the server computer(s) 20, the merchant computer(s) 30, and the distributor computer(s) 40, can have a web site or web sites associated therewith.

The apparatus 100 and method of the present invention can also provide for a cloud-based apparatus and method which can be utilized to perform any and/or all of the functionality described herein as being performed by the apparatus 100 of the present invention and which can also be utilized to perform cloud-based data and/or information access, processing, storage, utilization, and/or record keeping, of any data and/or information described herein as being processed and/or utilized by the apparatus 100 of the present invention.

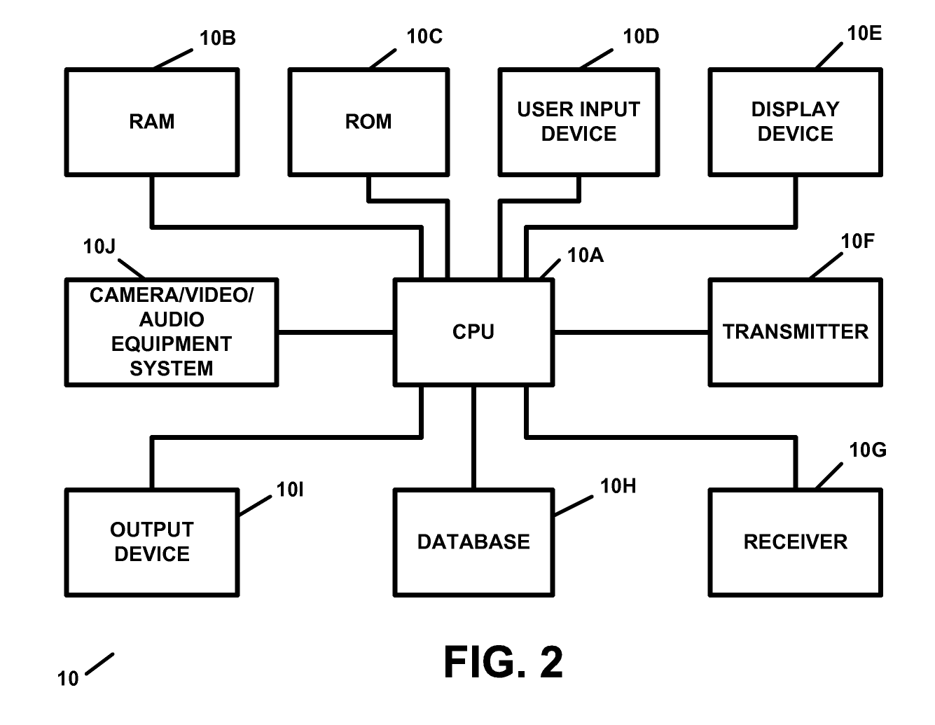

FIG. 2 illustrates a preferred embodiment of the central processing computer 10 of FIG. 1, in block diagram form. The central processing computer 10, in the preferred embodiment, is a computer, a computer system, a group of computers, a network computer, or a network computer system, or any other communication device, which can provide the functionality of, and which can be utilized as, a central processing computer 10. The central processing computer 10, in the preferred embodiment, can also be an Internet computer, an Internet server computer, and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, and a user input device 10D, for entering data, information, and/or commands, into the central processing computer 10, which includes any one or more of a keyboard, a scanner, a touch screen, a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus 100 of the present invention, into the central processing computer 10. The input device 10D can also be any other input device(s) which are or can be utilized with or in connection with any of the central processing computer(s) 10 described herein as being utilized in connection with the apparatus 100 of the present invention. The input devices 10D are also connected to or with, or linked to or with, the CPU 10A. In a preferred embodiment, the input device 10D can also include a retinal scanner, a fingerprint recognition device, a voice recognition device, or any other type or kind of biometric device which can be used for determining whether or not a user or operator of the central processing computer 10 is an authorized user, individual, or person. The central processing computer 10 also includes a display device 10E for displaying data and/or information to a user or operator.

The central processing computer 10 also includes a transmitter(s) 10F, for transmitting signals and/or data and/or information, or a message(s), to any one or more of the server computer(s) 20, the merchant computer(s) 30, the distributor computer(s) 40, and/or the communication device(s) 50, and/or to any other central processing computer(s) 10.

The central processing computer 10 also includes a receiver(s) 10G, for receiving signals and/or data and/or information, or a message(s), from any one or more of the server computer(s) 20, the merchant computer(s) 30, the distributor computer(s) 40, and/or the communication device(s) 50, and/or from any other central processing computer(s) 10.

The central processing computer 10 also includes a database(s) 10H, which is also connected to or linked with the CPU 10A, which can contain and/or include any and/or all of the data and/or information needed or desired for performing any and/or all of the functions and/or functionality described herein as being performed by the central processing computer 10 and/or the apparatus 100 and method of the present invention.

In a preferred embodiment, the database 10H contains and/or includes data and/or information regarding any of the herein-described users or individuals who or which use to the apparatus 100 and method of the present invention, and/or any data and/or information regarding any of the herein-described merchants who or which utilize the apparatus 100 and method of the present invention, and/or including, for each merchant, any and/or all of the respective goods, products, or merchandise, or respective services, offered for sale by, or sold by, each merchant, and/or any data and/or information regarding any of the herein-described distributors who or which utilize the apparatus 100 and method of the present invention, and/or including, for each distributor, any and/or all of the respective goods, products, or merchandise, or respective services, offered for sale by, sold by, or distributed by, each distributor.

In a preferred embodiment, the database 10H can contain and/or include, for each user, individual, consumer (hereinafter “user”) who or which utilizes the apparatus 100 and method of the present invention, the user's name, sign-in name or sign in information, password, address, billing address, shipping address, credit/charge debit number, bank account, saving account, checking, electronic money account, or any data and/or information regarding any other kind or type of payment identifier utilized by the user in transaction.

In a preferred embodiment, the database 10H can contain and/or include, for each user, individual, consumer (hereinafter “user”) who or which utilizes the apparatus 100 and method of the present invention, any of the user's on-line shopping account(s) with the apparatus 100, with the central processing computer 10, or with each merchant or distributor with which the user desires to have an on-line shopping account, which on-line shopping account can be utilized by the user to engage in on-line shopping transactions and/or Internet shopping transactions with the respective merchant or distributor.

In a preferred embodiment, the database 10H can contain and/or include, for each user, data and/or information regarding the user's gender, age, demographics, race, religion, nationality, education level or education information, occupation, employment information, information regarding the user's employer, and/or information regarding any members of the user's household or family, and/or social networking friends, followers, or other individuals.

In a preferred embodiment, the database 10H can also contain and/or include data and/or information regarding any account(s) which a user has established with, or which exists with, any of the herein-described merchants and/or distributors, data and/or information regarding any transaction(s), or on-line shopping event(s) or occurrence(s), which the user has engaged in with each merchant and/or distributor, data and/or information regarding, for each transaction or on-line event engaged in between the user with a merchant and/or distributor, data and/or information regarding goods, products, or merchandise, or services, purchased or browsed, data and/or information regarding any transaction histories for the user with each merchant and/or distributor, and/or data and/or information regarding goods, products, or merchandise, or services, purchased by or browsed by the user with each merchant and/or distributor.

In a preferred embodiment, the database 10H can also contain and/or include, for each user, data and/or information regarding the user's order history or order histories, interests, purchasing habits, use habits, and/or goods, products, or merchandise, or services, which the user is likely to purchase or browse on-line, data and/or information regarding the user's past transaction shopping carts or transaction receipts, and/or data and/or information regarding saved shopping carts from previous shopping transactions engaged in by the user in a transaction with any merchant(s) and/or distributor(s).

In a preferred embodiment, the database 10H can also contain and/or include, for each user, data and/or information regarding the user's shopping lists, habitual shopping lists, re-ordering lists, repeat purchasing lists, automatic re-ordering requests, and/or shopping habits, for or regarding any transactions with any merchants and/or distributors.

In a preferred embodiment, the database 10H can also contain and/or include, for each user, any information regarding any order pick-up or delivery instructions and/or habits of the user.

In a preferred embodiment, the database 10H can also contain and/or include, for each user, any data and/or information regarding the user, any of member(s) of the user's family or household, any relative of the user, and/or any individual under the user's care or supervision, and/or any data and/or information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs, and/or fitness restrictions, for or regarding each user and/or each member of the user's family or household, each relative of the user, and/or each individual under the user's care or supervision.

In a preferred embodiment, the database 10H can also contain and/or include, for each user, any member(s) of the user's family or household, any relative of the user, and/or any individual under the user's care or supervision, any data and/or information regarding any healthcare insurance or wellness incentives or programs for or associated with the user, the member(s) of the user's family or household, the relative of the user, and/or any individual under the user's care or supervision.

In a preferred embodiment, the database 10H can also contain and/or include, for each user, any data and/or information regarding the user, any of member(s) of the user's family or household, any relative of the user, and/or any individual under the user's care or supervision, and/or any data and/or information regarding any clothing or footwear, including, but not limited to size(s), type(s), kind(s), or style(s), for or regarding each user and/or each member of the user's family or household, each relative of the user, and/or each individual under the user's care or supervision.

In a preferred embodiment, the database 10H can also contain and/or include, for each user, any data and/or information regarding any of the user's merchant account(s), and/or distributor account(s), and/or any membership account(s), rewards account(s), club membership account(s), loyalty account(s), frequent customer account(s), discount membership account(s), repeat or regular customer account(s), and/or coupon account(s), which the user has with each merchant or distributor.

In a preferred embodiment, the database 10H can also contain and/or include any coupons, electronic coupons, digital coupons, certificates or other suitable items evidencing a rebate or rebates, or rewards points or rewards currency, which are issued by any merchant(s) or distributor(s) who or which utilizes the apparatus 100 and method of the present invention. In a preferred embodiment, each merchant can automatically apply any coupon(s), rebate(s), or reward(s) to a transaction, thereby dispensing with the need for a user to have to find, locate, handle, and/or apply, a coupon(s), rebate information, or rewards information, when making an on-line purchase from a merchant. In a preferred embodiment, each distributor conducting a transaction directly with a user can also automatically apply any coupon(s) to a transaction, thereby dispensing with the need for a user to have to find, locate, handle, and/or apply, a coupon(s) when making an on-line purchase from directly from a distributor.

In a preferred embodiment, the database 10H can also include any data and/or information, associated with any good, product, or item of merchandise, which can be utilized in order to automatically establish a marketing account, a membership account, a club membership account, a loyalty account, a rebate account, or a discount account, or any other account establishing a relationship, a marketing relationship, or a direct marketing relationship, with and between a user and any merchant and/or any distributor upon the user purchasing a good, product, or item of merchandise, from a merchant, from a distributor, or from a merchant and/or which is or provided or distributed by a distributor. In a preferred embodiment, the database 10H can also contain and/or include any account creation messages which are generated by the central processing computer 10.

In a preferred embodiment, the database 10H can also contain or include, for each user, any data and/or information regarding a user's request or instruction to be provided with or to receive alert messages or notification messages, via a e-mail message, a text message, pre-recorded telephone message, or via any other type, kind, or mode of communication, from the apparatus 100, from the central processing computer 10, or from any merchant computer 30 and/or distributor computer 40, which alert message or notification message can serve to alert or notify the user regarding any transaction involving any of the user's on-line shopping account(s) with the apparatus 100, or the central processing computer 10, or with any merchant or distributor.

In a preferred embodiment, the database 10H can also contain or include, for each user, any data and/or information regarding a user's request or instruction to be provided with or to receive alert messages or notification messages, containing information regarding the availability or issuance of coupons by a merchant, a distributor, the central processing computer 10, or the apparatus 100 (hereinafter “coupon alerts”), or containing information regarding sales or specials regarding any goods, products, or merchandise, or services, offered by a merchant or distributor, which can be purchased via the apparatus 100 of the present invention (hereinafter “sales alerts”), or containing information regarding the availability or the delivery of any goods, products, or merchandise at or to, or the availability of services at or from, a merchant or distributor (hereinafter “availability alerts” or “delivery alerts”), or containing information reminding a user or a time to order or to reorder certain goods, products, or merchandise, or services (hereinafter “order alerts” or “reorder alerts”), or containing information regarding the introduction or availability of new goods, products, or merchandise, or services, for purchase from or at (hereinafter “new products alerts” or “new services alerts”) a merchant or distributor.

In a preferred embodiment, the database 10H can also contain or include, for each user, or for each member of each user's household, family, or defined friend of family group, data and/or information regarding the social network or social networks in which the user and/or each member of each user's household, family, or defined friend of family group, belongs.

In a preferred embodiment, the database 10H can also contain and/or include, for each user, data and/or information regarding each communication device 50 which is or can be used by the user in utilizing the apparatus 100 and method of the present invention, including, but not limited to, data and/or information regarding an identification of each communication device 50, a description of, or type or kind of, the communication device 50, manufacturer, model number, and/or serial number or any other identification information, of, for, or regarding, the communication device 50, and/or the assigned telephone number, e-mail address, text messaging or SMS messaging number, and/or IP address, or any network identification information, of, for, or associated with, the communication device 50.

In a preferred embodiment, the database 10H can also contain and/or include, for each user, data and/or information regarding any language or languages in which the user desires to receive or obtain any of the text information or audio information, or any other information, described herein as being provided by the apparatus 100 of the present invention, or the language or languages in which the user desires to use the apparatus 100 of the present invention.

In a preferred embodiment, the database 10H can also contain and/or include, for each merchant and for each distributor who or which utilizes the apparatus 100 and method of the present invention, any and/or all data and/or information regarding the name, address, website, telephone number, e-mail address, and/or any other contact information for or regarding the respective merchant or distributor.

In a preferred embodiment, the database 10H can also contain and/or include, for each merchant and for each distributor who or which utilizes the apparatus 100 and method of the present invention, any and/or all data and/or information regarding any and/or all of the goods, products, or merchandise, or services, offered for sale by, or sold by the respective merchant or distributor and, for each good, product, or item of merchandise, the name or description of same, the store or stock keeping unit (SKU) number or information for or regarding same, the price of same, packaging information for or regarding same, number of units or quantity of same in a package offering, and/or any other data and/or information for or regarding each good, product, item of merchandise, or service, offered for sale by, or sold by, the respective merchant or distributor.

In a preferred embodiment, the database 10H can also contain and/or include, for each merchant and for each distributor, data and/or information regarding each user having an account with the merchant or the distributor, each user account or each on-line shopping account a user has with the respective merchant or distributor (also referred to as “user on-line shopping account”), transaction history information regarding each user account, or each user on-line shopping account, and/or any of the data and/or information described herein as being stored for or regarding each user, each user account, each user on-line shopping account, and/or for each user, data and/or information regarding the user's order history or order histories, interests, purchasing habits, use habits, and/or goods, products, or merchandise, or services, which the user is likely to purchase or browse on-line, data and/or information regarding the user's past transaction shopping carts or transaction receipts, and/or data and/or information regarding saved shopping carts from previous shopping transactions engaged in by the user in transactions with the respective merchant or distributor, data and/or information regarding the user's shopping lists, habitual shopping lists, re-ordering lists, repeat purchasing lists, automatic re-ordering requests, and/or shopping habits, for or regarding any transactions with the respective merchant or distributor, any information regarding any order pick-up or delivery instructions and/or habits of the user, and/or any data and/or information regarding the user, any of member(s) of the user's family or household, any relative of the user, and/or any individual under the user's care or supervision, and/or any data and/or information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs/restrictions, for or regarding each user and/or each member of the user's family or household, each relative of the user, and/or each individual under the user's care or supervision, and/or any data and/or information regarding the user, any of member(s) of the user's family or household, any relative of the user, and/or any individual under the user's care or supervision, and/or any data and/or information regarding any clothing or footwear, or type(s), kind(s), style(s), or size(s), of same, for or regarding each user and/or each member of the user's family or household, each relative of the user, and/or each individual under the user's care or supervision, and/or any data and/or information regarding any of the user's merchant account(s), and/or distributor account(s), and/or any membership account(s), rewards account(s), club membership account(s), loyalty account(s), frequent customer account(s), discount membership account(s), repeat or regular customer account(s), and/or coupon account(s), which the user has with the merchant or distributor, and/or any data and/or information regarding a user's request or instruction to be provided with, or to receive, any and/or all of the alert messages or notification messages described herein which can be requested by or provided to any user, including, but not limited to, any of the herein-described coupon alerts, sales alerts, availability alerts, delivery alerts, order alerts, reorder alerts, new products alerts, and/or new services alerts.

In a preferred embodiment, the database 10H can also contain and/or include, for each merchant and for each distributor who or which utilizes the apparatus 100 and method of the present invention, any and/or all data and/or information regarding any pictures, photographs, video clips, video, video footage, and/or any other visual information or presentation, or digital visual presentation of any and/or all of the goods, products, or items of merchandise, offered for sale by the respective merchant or distributor, as they are arranged, situated, and/or displayed, in the brick and mortar store environment of the merchant or the distributor.

In a preferred embodiment, the database 10H can contain and/or include, a picture(s), photograph(s), or other video image(s), or other visual depiction(s), which can be taken, photographed, or recorded, and/or stored, of the physical display of any and/or all of the goods, products, or items of merchandise, as they are arranged, presented, or displayed, in or on each merchant's or distributor's store aisles, store shelves, store racks, display stands, display racks, showcases, wall displays, point-of-sale displays, or any other type or kind of display, arrangement, or presentation, of any of the goods, products, or items of merchandise offered for sale by, or sold by, the respective merchant or distributor. In a preferred embodiment, any number of pictures, photographs, or other video images, or other visual depictions, can be photographed or recorded, and/or stored, and/or be can be linked together, for any and/or all or each type, kind, groups, or classification, of any goods, products, or items of merchandise, offered for sale by, or sold by, the respective merchant or distributor.

As and for an example, for cereals offered by a supermarket merchant, a picture or a series of pictures, or a photograph or a series of photographs, or a video clip or video footage, of the entire cereal aisle of the supermarket merchant can be taken, photographed, and/or recorded, and can be stored, so that a user, when buying cereal, can be provided with the picture or the series of pictures, or the photograph or the series of photographs, or the video clip or the video footage, of the entire cereal aisle so that the user can browse any and/or all of the various cereals offered by the supermarket merchant. In this same, similar, or analogous, manner, each and/or all of the various goods, products, or items of merchandise, offered for sale by, or sold by, the respective merchant or distributor can be photographed as they are arranged, offered, or presented, in the actual brick and mortar store environment of the merchant, whether they be arranged, presented, or situated on or in aisles, store shelves, store racks, display stands, display racks, showcases, wall displays, point-of-sale displays, or in or on any other type or kind of display, arrangement, or presentation. In a preferred embodiment, the database 10H can contain and/or include, for each respective merchant or distributor, any and/or all of the picture(s), series of pictures, photograph(s), series of photographs, video, video clips or video footage, or any other video image(s), or other visual depiction(s), of any and/or all of the various types or kinds of goods, products, or items of merchandise, offered for sale by, or sold by, the respective merchant or distributor.

In a preferred embodiment, the database 10H can also contain and/or include, for each respective merchant or distributor, any and/or all data and/or information regarding an index of all goods, products, or items of merchandise, the location of same in the merchant's store or stores or the distributor's store or stores, such as but not limited to aisle number of aisle numbers, racks, shelves, display cases, displays, show cases, walls, points-of-sale, or other location, where the respective goods, products, or items of merchandise, and/or where any clearance and/or discounted goods, products, or items of merchandise, are located, arranged, or presented, in the actual brick and mortar store or stores of the merchant or the distributor, the prices of same, a description of same, any social networking information regarding same, any sales regarding same, any specials regarding same, any available coupons which are offered for same, and/or any other information which may be of interest to any user.

In a preferred embodiment, the database 10H can also contain or include, any and/or all desired or needed information regarding a respective good(s), product(s), or item(s) of merchandise, sold by any merchant or distributor who or which utilizes the apparatus 100 and method of the present invention. As and for an example, in the case of a supermarket merchant which sells food and food products, that data and/or information for or regarding any good(s), product(s), or item(s) of merchandise, which is stored in the database 10H can include, for each and/or any and/or all food goods or food products, data and/or information regarding a food, including, but not limited to, its name, description, quantities/sizes available, nutritional content, nutritional information, caloric information, nutritional facts, dietary information, ingredients, percentage of daily requirements, price, expiration date, typical after purchase shelf life at home and/or data and/or information regarding any types or kinds of recipes, recipe ingredients, instructions, video recipe tutorials, cooking tutorials, diet regimen tutorials, wellness tutorials, and/or fitness tutorials and/or requirements.

In a preferred embodiment, the database 10H can also contain and/or include any and/or all of the herein-described merchandise group shopping page(s) of or associated with each merchant or distributor who or which utilizes the apparatus 100 and method of the present invention.

In a preferred embodiment, the database 10H can also contain and/or include any data and/or information regarding any of the herein-described user shopping events, including, but not limited to, for each shopping event, the time, date, and/or duration, of the shopping event, any user's selection of any merchant or merchants or distributor or distributors in the shopping event, store index page(s) provided in the shopping event, selected merchandise group(s) in the shopping event, merchandise group shopping page(s) provided in the shopping event, shopping cart(s) or electronic shopping cart(s) and/or any contents of same for the shopping event whether or not an order was placed or a transaction was completed, any information processed by the central processing computer 10 during check-out in the shopping event, any information regarding any application of any and/or all discounts, member discounts, merchant member discounts, merchant club shopping discounts, merchant reward points, or sale prices, price reductions, or instant rebates, or any coupons, manufacturer coupons, store coupons, merchant coupons, distributor coupons, or any other coupons in the shopping event, any information regarding final order price for the shopping event, any information regarding the any method or mode of payment and/or any payment information and/or payment identifier information in the shopping event, or any information regarding and/or including ant transaction confirmation message for the shopping event or an order message or a completed order message for the shopping event, and/or any and/or all information described herein regarding the shopping event or any contents of the user's shopping cart or electronic shopping cart when the user elected to exit the merchant's on-line store without making a purchase in or during the shopping event.

In a preferred embodiment, the database 10H can also contain and/or include, for each merchant, data and/or information regarding each distributor that provides goods, products, or merchandise, or services, to the merchant or to any of the merchants customers. In a preferred embodiment, the database 10H can also contain and/or include, for each distributor, data and/or information regarding each merchant that is supplied by or serviced by the distributor.

In a preferred embodiment, the database 10H can also contain and/or include and and/or all of the various types or kinds of alert messages or notification messages, or any information regarding users' requests for same, including but not limited to, any of the herein-described alert messages or notification messages described herein as being generated by the apparatus 100 and/or the central processing computer 10 and transmitted to each user or to each user's respective communication device 50.

In a preferred embodiment, the database 10H can also contain and/or include any information regarding any social networks with which the respective merchant or distributor is a member or subscriber.

In a preferred embodiment, the database 10H can also contain and/or include, for each user, data and/or information regarding each merchant computer 30 or distributor computer 40 which is or can be used by the respective merchant or distributor in utilizing the apparatus 100 and method of the present invention, including, but not limited to, data and/or information regarding an identification of each merchant computer 30 or distributor computer 40, a description of, or type or kind of, same, the manufacturer, model number, and/or serial number, of same, or any other identification information, of, for, or regarding, same, and/or the assigned telephone number, e-mail address, text messaging or SMS messaging number, and/or IP address, or any network identification information, of, for, or associated with, same.

In a preferred embodiment, the database 10H can also contain and/or include, any other data and/or information and/or any link(s) or hyperlink(s) to same, described herein as being utilized in connection with the apparatus 100 and method of the present invention.

In a preferred embodiment, the database 10H can also contain and/or include, any of the pictures, photographs, video clips, video recordings, video footage, tutorials, do-it-yourself tutorials, educational or training videos, recipes, or any other data and/or information described herein as being provided to any user by, or which can be accessed by or via, the apparatus 100 and method of the present invention, and/or any link(s) or hyperlink(s) to same.

In a preferred embodiment, the database 10H can also contain and/or include, any data and/or information, news stories, news articles, market research reports, or any other information regarding clothing styles, fashion styles, fashion ensembles, fashion accessories, reports or reviews for or regarding goods, products, or items of merchandise, product recalls, available upgrades, safety alerts, and/or any other information which may be deemed useful to any user of the apparatus 100 of the present invention.

In a preferred embodiment, the database 10H can also contain and/or include data and/or information regarding manufacturing date(s), production date(s), manufacturing time(s), production time(s), manufacturing location, production location, manufacturing or production batch number, lot number, and/or any other information, for or regarding any of the goods, products, or merchandise, which can be offered for sale, or sold, via the present invention. In a preferred embodiment, any data and/or information regarding manufacturing date(s), production date(s), manufacturing time(s), production time(s), manufacturing location, production location, manufacturing or production batch number, lot number, and/or any other information, for or regarding any of the goods, products, or merchandise, can be utilized to document goods, products, or merchandise, purchased by and user and/or can also be utilized to provide an alert message(s) or a notification message(s) when a good, product, or item of merchandise, might be the subject of a recall of any type or kind.

In a preferred embodiment, the database 10H can also contain and/or include, any data and/or information, and/or any software or software programs, or software applications or “apps”, for enabling any user to shop at or with more than one merchant during a same shopping event or shopping sitting with the apparatus 100 and method of the present invention. In a preferred embodiment, the apparatus 100 and method of the present invention can allow a user to also shop with more that one merchant using a split screen shopping format(s).

In a preferred embodiment, the database 10H can also contain and/or include, any data and/or information, and/or software or software programs or software applications or “apps” for performing a language translation of any text or audio information from one language to another.

In a preferred embodiment, the database 10H can also contain and/or include, any data and/or information, and/or software or software programs or software applications or “apps” for allowing a user to utilize the apparatus 100 and method of the present invention in connection with or via a cellular telephone, Smartphone, smart phone, personal digital assistant, tablet, tablet computer, and/or any other communication device 50 described herein as being utilized in connection with the apparatus 100 and method of the present invention, in a wireless communication environment or mobile communication environment.

In a preferred embodiment, the database 10H can also contain and/or include any data, information, software program(s), software, software application(s), or software “app” or “apps”, needed or desired for performing any of the operations, functions, and/or functionality, described herein as being performed by the central processing computer 10 and/or the apparatus 100 of the present invention.

In a preferred embodiment, the database 10H can also contain and/or include any and/or all of the data and/or information described herein as being stored in the respective databases of any of the herein-described server computer(s), merchant computer(s) 30, distributor computer(s) 40, and/or communication device(s) 50, and/or any other central processing computer(s) 10.

The central processing computer 10 also includes an output device 10I, which is also connected to the CPU 10A, for outputting any data and/or information, described herein. In a preferred embodiment, the output device 10I can be a printer, a display, a transmitter, a modem, and/or any other device which can be used to output data or information.

The central processing computer 10 can also include a camera, and/or a video and/or audio recording device 10J which, in a preferred embodiment, can include a camera, a video recording device, a microphone, and/or an audio recording device. The video and/or audio recording device 10J can be utilized to take a picture, record video, record a video clip, record sound, record audio, or record an audio clip, which can be stored in the central processing computer 10 and, in particular, in the database 10H of the central processing computer 10 for use or uses consistent with the apparatus 100 and method of the present invention.

In a preferred embodiment, the server computer(s) 20 can also contain or include any and/or all of the herein-described components, elements, and/or data and/or information, described herein as being utilized in the central processing computer 10 of FIG. 2. In this regard, in a preferred embodiment, the server computer 20 can include a central processing unit (CPU), a random access memory device(s) (RAM), a read only memory device(s) (ROM), a user input device, a transmitter(s), a receiver(s), a database, an output device, and/or a camera and/or a video and/or audio recording device.

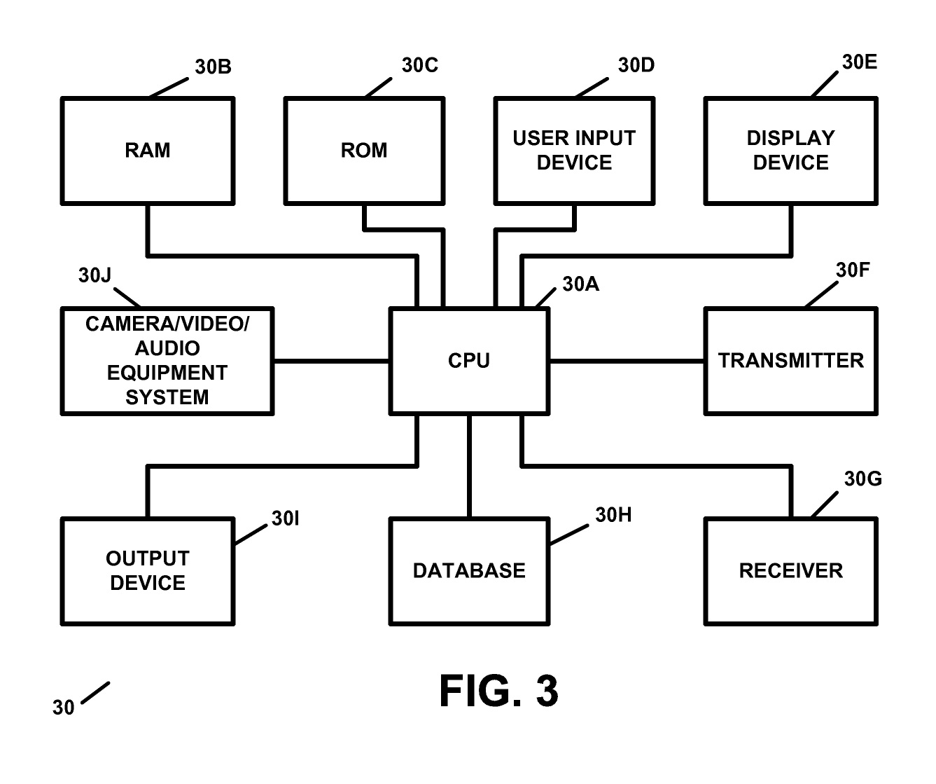

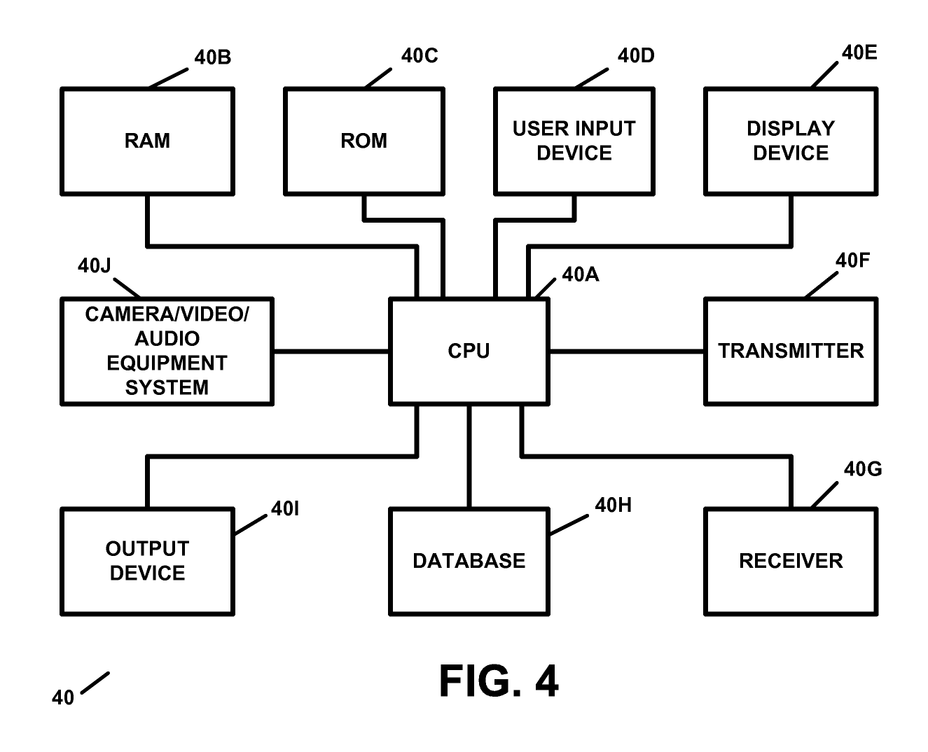

FIG. 3 illustrates a preferred embodiment of the merchant computer 30 of FIG. 1, in block diagram form. The merchant computer 30, in a preferred embodiment, is a computer, a computer system, a group of computers, a network computer, or a network computer system, or any other communication device, which can provide the functionality of, and which can be utilized as, a merchant computer 30. The merchant computer 30, in a preferred embodiment, can also be an Internet computer, an Internet server computer, and/or a web site server computer. In a preferred embodiment, the merchant computer 30 can also be, or can include, a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, Internet-enabled eyewear or glasses, Internet-enabled clothing or articles of clothing or footwear, Internet-enabled accessories, Internet-enabled jewelry and time pieces, a telephone, a television, an interactive television, a digital television, a smart television or entertainment device, an internet-enabled television or entertainment device, or any other suitable device, which can be equipped to perform the functions described herein as being performed by the communication device.

In a preferred embodiment, the merchant computer 30 includes a central processing unit or CPU 30A, which, in a preferred embodiment, is a microprocessor. The CPU 30A may also be a microcomputer, a minicomputer, a macro-computer, and/or a mainframe computer, depending upon the application.

The merchant computer 30 also includes a random access memory device(s) 30B (RAM) and a read only memory device(s) 30C (ROM), each of which is connected to the CPU 30A, and a user input device 30D, for entering data, information, and/or commands, into the merchant computer 30, which includes any one or more of a keyboard, a scanner, a touch screen, a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus 100 of the present invention, into the merchant computer 30. The input device 30D can also be any other input device(s) which are or can be utilized with or in connection with any of the merchant computer(s) 30 described herein as being utilized in connection with the apparatus 100 of the present invention. The input devices 30D are also connected to or with, or linked to or with, the CPU 30A. In a preferred embodiment, the input device 30D can also include a retinal scanner, a fingerprint recognition device, a voice recognition device, or any other type or kind of biometric device which can be used for determining whether or not a user or operator of the merchant computer 30 is an authorized user, individual, or person. The merchant computer 30 also includes a display device 30E for displaying data and/or information to a user or operator.

The merchant computer 30 also includes a transmitter(s) 30F, for transmitting signals and/or data and/or information, or a message(s), to any one or more of the central processing computer(s) 10, the server computer(s) 20, the distributor computer(s) 40, and/or the communication device(s) 50, and/or to any other any other merchant computer(s) 30.

The merchant computer 30 also includes a receiver(s) 10G, for receiving signals and/or data and/or information, or a message(s), from any one or more of the any one or more of the central processing computer(s) 10, the server computer(s) 20, the distributor computer(s) 40, and/or the communication device(s) 50, and/or from any other any other merchant computer(s) 30.

The merchant computer 30 also includes a database(s) 30H, which is also connected to or linked with the CPU 30A, which can contain and/or include any and/or all of the data and/or information needed or desired for performing any and/or all of the functions and/or functionality described herein as being performed by the merchant computer 30 and/or apparatus 100 and method of the present invention.

In a preferred embodiment, the database 30H contains and/or includes, for each user having an account with the merchant, data and/or information regarding any of these users, the user's respective account information or account number, name, sign-in name or sign in information, password, address, billing address, shipping address, credit/charge debit number, bank account, saving account, checking, electronic money account, or any data and/or information regarding any other kind or type of payment identifier utilized by the user in transaction.

In a preferred embodiment, the database 30H can contain and/or include, for each user having an account with the merchant, any of the user's on-line shopping account(s) with the merchant, and/or any data and/or information regarding the user's gender, age, demographics, race, religion, nationality, education level or education information, occupation, employment information, information regarding the user's employer, and/or information regarding any members of the user's household or family, and/or social networking friends, followers, or other individuals.

In a preferred embodiment, the database 30H can also contain and/or include data and/or information regarding any account(s) which a user has established with, or which exists with, the merchant, data and/or information regarding any transaction(s), or on-line shopping event(s) or occurrence(s), which the user has engaged in with the merchant, data and/or information regarding, for each transaction or on-line event engaged in between the user with the merchant, data and/or information regarding goods, products, or merchandise, or services, purchased or browsed, data and/or information regarding any transaction histories for the user with the merchant, and/or data and/or information regarding goods, products, or merchandise, or services, purchased by or browsed by the user with the merchant.

In a preferred embodiment, the database 30H can also contain and/or include, for each user having an account with the merchant, data and/or information regarding the user's order history or order histories with the merchant, interests, purchasing habits, use habits, and/or goods, products, or merchandise, or services, which the user is likely to purchase or browse on-line, data and/or information regarding the user's past transaction shopping carts or transaction receipts with or involving the merchant, and/or data and/or information regarding saved shopping carts from previous shopping transactions engaged in by the user in transaction with the merchant.

In a preferred embodiment, the database 30H can also contain and/or include, for each user having an account with the merchant, data and/or information regarding the user's shopping lists, habitual shopping lists, re-ordering lists, repeat purchasing lists, automatic re-ordering requests, and/or shopping habits, for or regarding any transactions with the merchant.

In a preferred embodiment, the database 300H can also contain and/or include, for each user having an account with the merchant, any information regarding any order pick-up or delivery instructions and/or habits of the user.

In a preferred embodiment, the database 30H can also contain and/or include, for each user having an account with the merchant, any data and/or information regarding the user, any of member(s) of the user's family or household, any relative of the user, and/or any individual under the user's care or supervision, and/or any data and/or information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs, and/or fitness restrictions, for or regarding each user and/or each member of the user's family or household, each relative of the user, and/or each individual under the user's care or supervision.

In a preferred embodiment, the database 30H can also contain and/or include, for each user having an account with the merchant, any member(s) of the user's family or household, any relative of the user, and/or any individual under the user's care or supervision, any data and/or information regarding any healthcare insurance or wellness incentives or programs for or associated with the user, the member(s) of the user's family or household, the relative of the user, and/or any individual under the user's care or supervision.

In a preferred embodiment, the database 30H can also contain and/or include, for each user having an account with the merchant, any data and/or information regarding the user, any of member(s) of the user's family or household, any relative of the user, and/or any individual under the user's care or supervision, and/or any data and/or information regarding any clothing or footwear, including, but not limited to size(s), types, kinds, or styles, for or regarding each user and/or each member of the user's family or household, each relative of the user, and/or each individual under the user's care or supervision.

In a preferred embodiment, the database 30H can also contain and/or include, for each user having an account with the merchant, any data and/or information regarding any of the user's merchant account(s), and/or any membership account(s), rewards account(s), club membership account(s), loyalty account(s), frequent customer account(s), discount membership account(s), repeat or regular customer account(s), and/or coupon account(s), which the user has with the merchant.

In a preferred embodiment, the database 30H can also contain and/or include any coupons, electronic coupons, digital coupons, certificates or other suitable items evidencing a rebate or rebates, or rewards points or rewards currency, which are issued by the merchant(s). In a preferred embodiment, the merchant can automatically apply any coupon(s), rebate(s), or reward(s) to a transaction, thereby dispensing with the need for a user to have to find, locate, handle, and/or apply, a coupon(s), rebate information, or rewards information, when making an on-line purchase from or with the merchant.

In a preferred embodiment, the database 30H can also include any data and/or information, associated with any good, product, or item of merchandise, which can be utilized in order to automatically establish a marketing account, a membership account, a club membership account, a loyalty account, a rebate account, or a discount account, or any other account establishing a relationship, a marketing relationship, or a direct marketing relationship, with and between a user and the merchant upon the user purchasing a good, product, or item of merchandise, from the merchant.

In a preferred embodiment, the database 30H can also contain or include, for each user having an account with the merchant, any data and/or information regarding a user's request or instruction to be provided with or to receive alert messages or notification messages, via a e-mail message, a text message, pre-recorded telephone message, or via any other type, kind, or mode of communication, from the merchant, from the merchant computer 30, from the apparatus 100 or central processing computer 10, or from any other merchant computer 30 and/or distributor computer 40, which alert message or notification message can serve to alert or notify the user regarding any transaction involving any of the user's on-line shopping account(s) with the merchant.

In a preferred embodiment, the database 30H can also contain or include, for each user having an account with the merchant, any data and/or information regarding a user's request or instruction to be provided with or to receive alert messages or notification messages, containing information regarding the availability or issuance of coupons by the merchant, a distributor, the central processing computer 10, or the apparatus 100 (“coupon alerts”), or containing information regarding sales or specials of or offered by the merchant regarding any goods, products, or merchandise, or services, which can be purchased from the merchant via the apparatus 100 of the present invention (“sales alerts”), or containing information regarding the availability or the delivery of any goods, products, or merchandise, or the availability of services, at or to the merchant (“availability alerts” or “delivery alerts”), or containing information reminding a user of a time to order or to reorder certain goods, products, or merchandise, or services (“order alerts” or “reorder alerts”) from the merchant, or containing information regarding the introduction or availability of new goods, products, or merchandise, or services, available for purchase at or from the merchant (“availability alerts”).

In a preferred embodiment, the database 30H can also contain or include, for each user having an account with the merchant, data and/or information regarding the social network or social networks in which the user and/or each member of each user's household, family, or defined friend of family group, belongs.

In a preferred embodiment, the database 30H can also contain and/or include, for each user having an account with the merchant, data and/or information regarding each communication device 50 which is or can be used by the user in utilizing the apparatus 100 and method of the present invention, including, but not limited to, data and/or information regarding an identification of each communication device 50, a description of, or type or kind of, the communication device 50, manufacturer, model number, and/or serial number or any other identification information, of, for, or regarding, the communication device 50, and/or the assigned telephone number, e-mail address, text messaging or SMS messaging number, and/or IP address, or any network identification information, of, for, or associated with, the communication device 50.

In a preferred embodiment, the database 30H can also contain and/or include, for each user having an account with the merchant, data and/or information regarding any language or languages in which the user desires to receive or obtain any of the text information or audio information, or any other information, described herein as being provided by the apparatus 100 of the present invention, or the language or languages in which the user desires to use the apparatus 100 of the present invention.

In a preferred embodiment, the database 30H can also contain and/or include, for the merchant, any and/or all data and/or information regarding the name, address, website, telephone number, e-mail address, and/or any other contact information for or regarding the merchant.

In a preferred embodiment, the database 30H can also contain and/or include, for the merchant, any and/or all data and/or information regarding any and/or all of the goods, products, or merchandise, or services, offered for sale by, or sold by the merchant and, for each good, product, or item of merchandise, the name or description of same, the store or stock keeping unit (SKU) number or information for or regarding same, the price of same, packaging information for or regarding same, number of units or quantity of same in a package offering, and/or any other data and/or information for or regarding each good, product, item of merchandise, or service, offered for sale by, or sold by, the merchant.

In a preferred embodiment, the database 30H can also contain and/or include, for the merchant, data and/or information regarding each user having an account with the merchant, each user account or each on-line shopping account each user has with the merchant, transaction history information regarding each user account, or each user on-line shopping account, and/or any of the data and/or information described herein as being stored for or regarding each user having an account with the merchant, each user account, each user on-line shopping account, and/or for each user, data and/or information regarding the user's order history or order histories, interests, purchasing habits, use habits, and/or goods, products, or merchandise, or services, which the user is likely to purchase or browse on-line, data and/or information regarding the user's past transaction shopping carts or transaction receipts, and/or data and/or information regarding saved shopping carts from previous shopping transactions engaged in by the user in a transaction(s) with the merchant, data and/or information regarding the user's shopping lists, habitual shopping lists, re-ordering lists, repeat purchasing lists, automatic re-ordering requests, and/or shopping habits, for or regarding any transactions with the merchant, any information regarding any order pick-up or delivery instructions and/or habits of the user, and/or any data and/or information regarding the user, any of member(s) of the user's family or household, any relative of the user, and/or any individual under the user's care or supervision, and/or any data and/or information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs/restrictions, for or regarding each user and/or each member of the user's family or household, each relative of the user, and/or each individual under the user's care or supervision, and/or any data and/or information regarding the user, any of member(s) of the user's family or household, any relative of the user, and/or any individual under the user's care or supervision, and/or any data and/or information regarding any clothing or footwear, or type(s), kind(s), style(s), or size(s), of same, for or regarding each user and/or each member of the user's family or household, each relative of the user, and/or each individual under the user's care or supervision, and/or any data and/or information regarding any of the user's merchant account(s), and/or any membership account(s), rewards account(s), club membership account(s), loyalty account(s), frequent customer account(s), discount membership account(s), repeat or regular customer account(s), and/or coupon account(s), which the user has with the merchant, and/or any data and/or information regarding a user's request or instruction to be provided with or to receive any and/or all of the alert messages or notification messages described herein which can be requested by, or provided to, the user, including, but not limited to, any of the herein-described coupon alerts, sales alerts, availability alerts, delivery alerts, order alerts, reorder alerts, new products alerts, and/or new services alerts.

In a preferred embodiment, the database 30H can also contain and/or include, for the merchant, any and/or all data and/or information regarding any pictures, photographs, video clips, video, video footage, and/or any other visual information or presentation, or digital visual presentation of any and/or all of the goods, products, or items of merchandise, offered for sale by the merchant, as same are arranged, situated, or presented in the merchant's brick and mortar store environment.

In a preferred embodiment, the database 30H can contain and/or include, a picture(s), photograph(s), or other video image(s), or other visual depiction(s), which can be taken, photographed, or recorded, and/or stored, of the physical display of any and/or all of the goods, products, or items of merchandise, as they are arranged, presented, or displayed, in or on the merchant's store aisles, store shelves, store racks, display stands, display racks, showcases, wall displays, point-of-sale displays, or any other type or kind of display, arrangement, or presentation, of any of the goods, products, or items of merchandise offered for sale by, or sold by, the merchant. In a preferred embodiment, any number of pictures, photographs, or other video images, or other visual depictions, can be photographed or recorded, and/or stored, and/or be can be linked together, for any and/or all or each type, kind, groups, or classification, of any goods, products, or items of merchandise, offered for sale by, or sold by, the merchant.

As and for an example, for cereals offered by a supermarket merchant, a picture or a series of pictures, or a photograph or a series of photographs, or a video clip or video footage, of the entire cereal aisle of the supermarket merchant can be taken, photographed, and/or recorded, and can be stored, so that a user, when buying cereal, can be provided with the picture or the series of pictures, or the photograph or the series of photographs, or the video clip or the video footage, of the entire cereal aisle so that the user can browse any and/or all of the various cereals offered by the supermarket merchant. In this same, similar, or analogous, manner, each and/or all of the various goods, products, or items of merchandise, offered for sale by, or sold by, the respective merchant can be photographed as they are arranged, offered, or presented, in the actual brick and mortar store environment of the merchant, whether they be arranged, presented, or situated on or in aisles, store shelves, store racks, display stands, display racks, showcases, wall displays, point-of-sale displays, or in or on any other type or kind of display, arrangement, or presentation. In a preferred embodiment, the database 30H can contain and/or include, for the merchant, any and/or all of the picture(s), series of pictures, photograph(s), series of photographs, video, video clips or video footage, or any other video image(s), or other visual depiction(s), of any and/or all of the various types or kinds of goods, products, or items of merchandise, offered for sale by, or sold by, the merchant.

In a preferred embodiment, the database 30H can also contain and/or include, for or regarding the merchant, any and/or all data and/or information regarding an index of all goods, products, or items of merchandise, the location of same in the merchant's store(s), such as but not limited to aisle number of aisle numbers, racks, shelves, display cases, displays, show cases, walls, points-of-sale, or other locations, where the respective goods, products, or items of merchandise, and/or where any clearance and/or discounted goods, products, or items of merchandise, are located, arranged, or presented, in the actual brick and mortar store or stores of the merchant, the prices of same, a description of same, any social networking information regarding same, any sales regarding same, any specials regarding same, any available coupons which are offered for same, and/or any other information which may be of interest to any user.

In a preferred embodiment, the database 30H can also contain or include, any and/or all desired or needed information regarding a respective good(s), product(s), or item(s) of merchandise sold by the merchant. As and for an example, in the case of a supermarket merchant which sells food and food products, that data and/or information for or regarding any good(s), product(s), or item(s) of merchandise, which is stored in the database 30H can include, for each and/or any and/or all food goods or food products, data and/or information regarding a food, including, but not limited to, its name, description, quantities/sizes available, nutritional content, nutritional information, caloric information, nutritional facts, dietary information, ingredients, percentage of daily requirements, price, expiration date, typical after purchase shelf life at home, and/or data and/or information regarding any types or kinds of recipes, recipe ingredients, instructions, video recipe tutorials, cooking tutorials, diet regimen tutorials, wellness tutorials, and/or fitness tutorials and/or requirements.

In a preferred embodiment, the database 30H can also contain and/or include, for or regarding the merchant, data and/or information regarding each distributor that provides goods, products, or merchandise, or services, to the merchant or to any of the merchant's customers.

In a preferred embodiment, the database 30H can also contain and/or include any and/or all of the herein-described merchandise group shopping page(s) of or associated with the merchant.

In a preferred embodiment, the database 30H can also contain and/or include any data and/or information regarding any of the herein-described user shopping events with the merchant, including, but not limited to, for each shopping event, the time, date, and/or duration, of the shopping event, any user's selection of any merchant or merchants or distributor or distributors in the shopping event, store index page(s) provided in the shopping event, selected merchandise group(s) in the shopping event, merchandise group shopping page(s) provided in the shopping event, shopping cart(s) or electronic shopping cart(s) and/or any contents of same for the shopping event whether or not an order was placed or a transaction was completed, any information processed by the central processing computer 10 during check-out in the shopping event, any information regarding any application of any and/or all discounts, member discounts, merchant member discounts, merchant club shopping discounts, merchant reward points, or sale prices, price reductions, or instant rebates, or any coupons, manufacturer coupons, store coupons, merchant coupons, distributor coupons, or any other coupons in the shopping event, any information regarding final order price for the shopping event, any information regarding the any method or mode of payment and/or any payment information and/or payment identifier information in the shopping event, or any information regarding and/or including ant transaction confirmation message for the shopping event or completed order message for the shopping event, and/or any and/or all information described herein regarding the shopping event or any contents of the user's shopping cart or electronic shopping cart when the user elected to exit the merchant's on-line store without making a purchase in or during the shopping event.

In a preferred embodiment, the database 30H can also contain and/or include and and/or all of the various types or kinds of alert messages or notification messages, or information regarding users' requests for same, including but not limited to, any of the herein-described alert messages or notification messages described herein as being generated by the apparatus 100 and/or the central processing computer 10 and transmitted to each user or to each user's respective communication device 50.

In a preferred embodiment, the database 30H can also contain and/or include any information regarding any social networks with which the merchant is a member or subscriber.

In a preferred embodiment, the database 30H can also contain and/or include, for each user having an account with the merchant, data and/or information regarding each merchant computer 30 which is or can be used by the respective merchant in utilizing the apparatus 100 and method of the present invention, including, but not limited to, data and/or information regarding an identification of each merchant computer 30, a description of, or type or kind of, same, the manufacturer, model number, and/or serial number, of same, or any other identification information, of, for, or regarding, same, and/or the assigned telephone number, e-mail address, text messaging or SMS messaging number, and/or IP address, or any network identification information, of, for, or associated with, same.

In a preferred embodiment, the database 30H can also contain and/or include, any other data and/or information and/or any link(s) or hyperlink(s) to same, described herein as being utilized in connection with the apparatus 100 and method of the present invention and/or in connection with the merchant computer 30.

In a preferred embodiment, the database 30H can also contain and/or include, any of the pictures, photographs, video clips, video recordings, video footage, tutorials, do-it-yourself tutorials, educational or training videos, recipes, or any other data and/or information described herein as being provided by the merchant, or which can be accessed from or via the merchant computer 30, and/or any link(s) or hyperlink(s) to same.

In a preferred embodiment, the database 30H can also contain and/or include, any data and/or information, news stories, news articles, market research reports, or any other information regarding clothing styles, fashion styles, fashion ensembles, fashion accessories, reports or reviews for or regarding goods, products, or items of merchandise, product recalls, available upgrades, safety alerts, and/or any other information which may be deemed useful to any user having an account with the merchant.

In a preferred embodiment, the database 30H can also contain and/or include data and/or information regarding manufacturing date(s), production date(s), manufacturing time(s), production time(s), manufacturing location, production location, manufacturing or production batch number, lot number, and/or any other information, for or regarding any of the goods, products, or merchandise, which can be offered for sale, or sold, by the merchant. In a preferred embodiment, any data and/or information regarding manufacturing date(s), production date(s), manufacturing time(s), production time(s), manufacturing location, production location, manufacturing or production batch number, lot number, and/or any other information, for or regarding any of the goods, products, or merchandise, can be utilized to document goods, products, or merchandise, purchased from the merchant and/or can also be utilized to provide an alert message(s) or a notification message(s) when a good, product, or item of merchandise, might be the subject of a recall of any type or kind.

In a preferred embodiment, the database 30H can also contain and/or include, any data and/or information, and/or software or software programs or software applications or “apps” for performing a language translation of any text or audio information from one language to another.

In a preferred embodiment, the database 30H can also contain and/or include, any data and/or information, and/or software or software programs or software applications or “apps” for allowing a user to access and/or interact with the merchant computer 30 with or via a cellular telephone, Smartphone, smart phone, personal digital assistant, tablet, tablet computer, and/or any other communication device 50 described herein as being utilized in connection with the apparatus 100 and method of the present invention, in a wireless communication environment or mobile communication environment.

In a preferred embodiment, the database 30H can also contain and/or include any data, information, software program(s), software, software application(s), or software “app” or “apps”, needed or desired for performing any of the operations, functions, and/or functionality, described herein as being performed by the merchant computer 30, the central processing computer 10 and/or the apparatus 100 of the present invention.

In a preferred embodiment, the database 30H can also contain and/or include any and/or all of the data and/or information described herein as being stored in the respective databases of any of the herein-described central processing computer(s) 10, server computer(s) 20, distributor computer(s) 40, and/or communication device(s) 50, and/or any other merchant computer(s) 30.

The merchant computer 30 also includes an output device 301, which is also connected to the CPU 30A, for outputting any data and/or information, described herein. In a preferred embodiment, the output device 301 can be a printer, a display, a transmitter, a modem, and/or any other device which can be used to output data or information.

The merchant computer 30 can also include a camera, and/or a video and/or audio recording device 30J which, in a preferred embodiment, can include a camera, a video recording device, a microphone, and/or an audio recording device. The video and/or audio recording device 10J can be utilized to take a picture, record video, record a video clip, record sound, record audio, or record an audio clip, which can be stored in the merchant computer 30 and, in particular, in the database 30H of the merchant computer 30 for use or uses consistent with the apparatus 100 and method of the present invention.

In a preferred embodiment, the distributor computer 40 includes a central processing unit or CPU 40A, which, in a preferred embodiment, is a microprocessor. The CPU 40A may also be a microcomputer, a minicomputer, a macro-computer, and/or a mainframe computer, depending upon the application.

The distributor computer 40 also includes a random access memory device(s) 40B (RAM) and a read only memory device(s) 40C (ROM), each of which is connected to the CPU 40A, and a user input device 40D, for entering data, information, and/or commands, into the distributor computer 40, which includes any one or more of a keyboard, a scanner, a touch screen, a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus 100 of the present invention, into the distributor computer 40. The input device 40D can also be any other input device(s) which are or can be utilized with or in connection with any of the distributor computer(s) 40 described herein as being utilized in connection with the apparatus 100 of the present invention. The input devices 40D are also connected to or with, or linked to or with, the CPU 40A. In a preferred embodiment, the input device 40D can also include a retinal scanner, a fingerprint recognition device, a voice recognition device, or any other type or kind of biometric device which can be used for determining whether or not a user or operator of the distributor computer 40 is an authorized user, individual, or person. The distributor computer 40 also includes a display device 40E for displaying data and/or information to a user or operator.

The distributor computer 40 also includes a transmitter(s) 40F, for transmitting signals and/or data and/or information, or a message(s), to any one or more of the central processing computer(s) 10, the server computer(s) 20, the merchant computer(s) 30, and/or the communication device(s) 50, and/or to any other any other distributor computer(s) 40.

The distributor computer 40 also includes a receiver(s) 10G, for receiving signals and/or data and/or information, or a message(s), from any one or more of the any one or more of the central processing computer(s) 10, the server computer(s) 20, the merchant computer(s) 40, and/or the communication device(s) 50, and/or from any other any other distributor computer(s) 40.

The distributor computer 40 also includes a database(s) 40H, which is also connected to or linked with the CPU 40A, which can contain and/or include any and/or all of the data and/or information needed or desired for performing any and/or all of the functions and/or functionality described herein as being performed by the distributor computer 40 and/or the apparatus 100 and method of the present invention.

In a preferred embodiment, the database 40H contains and/or includes, for each user having an account with the distributor, data and/or information regarding any of these users, the user's respective account information or account number, name, sign-in name or sign in information, password, address, billing address, shipping address, credit/charge debit number, bank account, saving account, checking, electronic money account, or any data and/or information regarding any other kind or type of payment identifier utilized by the user in transaction.

In a preferred embodiment, the database 40H can contain and/or include, for each user having an account with the distributor, any of the user's on-line shopping account(s) with the distributor, and/or any data and/or information regarding the user's gender, age, demographics, race, religion, nationality, education level or education information, occupation, employment information, information regarding the user's employer, and/or information regarding any members of the user's household or family, and/or social networking friends, followers, or other individuals.

In a preferred embodiment, the database 40H can also contain and/or include data and/or information regarding any account(s) which a user has established with, or which exists with, the distributor, data and/or information regarding any transaction(s), or on-line shopping event(s) or occurrence(s), which the user has engaged in with the distributor, data and/or information regarding, for each transaction or on-line event engaged in between the user with the distributor, data and/or information regarding goods, products, or merchandise, or services, purchased or browsed, data and/or information regarding any transaction histories for the user with the distributor, and/or data and/or information regarding goods, products, or merchandise, or services, purchased by or browsed by the user with the distributor.

In a preferred embodiment, the database 40H can also contain and/or include, for each user having an account with the distributor, data and/or information regarding the user's order history or order histories with the distributor, interests, purchasing habits, use habits, and/or goods, products, or merchandise, or services, which the user is likely to purchase or browse on-line, data and/or information regarding the user's past transaction shopping carts or transaction receipts with or involving the distributor, and/or data and/or information regarding saved shopping carts from previous shopping transactions engaged in by the user in transaction with the distributor.

In a preferred embodiment, the database 40H can also contain and/or include, for each user having an account with the distributor, data and/or information regarding the user's shopping lists, habitual shopping lists, re-ordering lists, repeat purchasing lists, automatic re-ordering requests, and/or shopping habits, for or regarding any transactions with the distributor.

In a preferred embodiment, the database 30H can also contain and/or include, for each user having an account with the distributor, any information regarding any order pick-up or delivery instructions and/or habits of the user.

In a preferred embodiment, the database 40H can also contain and/or include, for each user having an account with the distributor, any data and/or information regarding the user, any of member(s) of the user's family or household, any relative of the user, and/or any individual under the user's care or supervision, and/or any data and/or information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs, and/or fitness restrictions, for or regarding each user and/or each member of the user's family or household, each relative of the user, and/or each individual under the user's care or supervision.

In a preferred embodiment, the database 40H can also contain and/or include, for each user having an account with the distributor, any member(s) of the user's family or household, any relative of the user, and/or any individual under the user's care or supervision, any data and/or information regarding any healthcare insurance or wellness incentives or programs for or associated with the user, the member(s) of the user's family or household, the relative of the user, and/or any individual under the user's care or supervision.

In a preferred embodiment, the database 40H can also contain and/or include, for each user having an account with the distributor, any data and/or information regarding the user, any of member(s) of the user's family or household, any relative of the user, and/or any individual under the user's care or supervision, and/or any data and/or information regarding any clothing or footwear, including, but not limited to size(s), types, kinds, or styles, for or regarding each user and/or each member of the user's family or household, each relative of the user, and/or each individual under the user's care or supervision.

In a preferred embodiment, the database 40H can also contain and/or include, for each user having an account with the distributor, any data and/or information regarding any of the user's distributor account(s), and/or any membership account(s), rewards account(s), club membership account(s), loyalty account(s), frequent customer account(s), discount membership account(s), repeat or regular customer account(s), and/or coupon account(s), which the user has with the distributor.

In a preferred embodiment, the database 40H can also contain and/or include any coupons, electronic coupons, digital coupons, certificates or other suitable items evidencing a rebate or rebates, or rewards points or rewards currency, which are issued by the distributor(s). In a preferred embodiment, the distributor can automatically apply any coupon(s), rebate(s), or reward(s) to a transaction, thereby dispensing with the need for a user to have to find, locate, handle, and/or apply, a coupon(s), rebate information, or rewards information, when making an on-line purchase from or with the distributor.

In a preferred embodiment, the database 40H can also include any data and/or information, associated with any good, product, or item of merchandise, which can be utilized in order to automatically establish a marketing account, a membership account, a club membership account, a loyalty account, a rebate account, or a discount account, or any other account establishing a relationship, a marketing relationship, or a direct marketing relationship, with and between a user and the distributor upon the user purchasing a good, product, or item of merchandise, from the distributor.

In a preferred embodiment, the database 40H can also contain or include, for each user having an account with the distributor, any data and/or information regarding a user's request or instruction to be provided with or to receive alert messages or notification messages, via a e-mail message, a text message, pre-recorded telephone message, or via any other type, kind, or mode of communication, from the distributor, from the distributor computer 40, from the apparatus 100 or central processing computer 10, or from any other merchant computer 30 and/or distributor computer 40, which alert message or notification message can serve to alert or notify the user regarding any transaction involving any of the user's on-line shopping account(s) with the distributor.

In a preferred embodiment, the database 40H can also contain or include, for each user having an account with the distributor, any data and/or information regarding a user's request or instruction to be provided with or to receive alert messages or notification messages, containing information regarding the availability or issuance of coupons by the distributor, a merchant, the central processing computer 10, or the apparatus 100 (“coupon alerts”), or containing information regarding sales or specials of or offered by the distributor regarding any goods, products, or merchandise, or services, which can be purchased from the distributor via the apparatus 100 of the present invention (“sales alerts”), or containing information regarding the availability or the delivery of any goods, products, or merchandise, or the availability of services, at or to the distributor (“availability alerts” or “delivery alerts”), or containing information reminding a user of a time to order or to reorder certain goods, products, or merchandise, or services (“order alerts” or “reorder alerts”) from the distributor, or containing information regarding the introduction or availability of new goods, products, or merchandise, or services, available for purchase at or from the distributor (“availability alerts”).

In a preferred embodiment, the database 40H can also contain or include, for each user having an account with the distributor, data and/or information regarding the social network or social networks in which the user and/or each member of each user's household, family, or defined friend of family group, belongs.

In a preferred embodiment, the database 40H can also contain and/or include, for each user having an account with the distributor, data and/or information regarding each communication device 50 which is or can be used by the user in utilizing the apparatus 100 and method of the present invention, including, but not limited to, data and/or information regarding an identification of each communication device 50, a description of, or type or kind of, the communication device 50, manufacturer, model number, and/or serial number or any other identification information, of, for, or regarding, the communication device 50, and/or the assigned telephone number, e-mail address, text messaging or SMS messaging number, and/or IP address, or any network identification information, of, for, or associated with, the communication device 50.

In a preferred embodiment, the database 40H can also contain and/or include, for each user having an account with the distributor, data and/or information regarding any language or languages in which the user desires to receive or obtain any of the text information or audio information, or any other information, described herein as being provided by the apparatus 100 of the present invention, or the language or languages in which the user desires to use the apparatus 100 of the present invention.

In a preferred embodiment, the database 40H can also contain and/or include, for the distributor, any and/or all data and/or information regarding the name, address, website, telephone number, e-mail address, and/or any other contact information for or regarding the distributor.

In a preferred embodiment, the database 40H can also contain and/or include, for the distributor, any and/or all data and/or information regarding any and/or all of the goods, products, or merchandise, or services, offered for sale by, or sold by the distributor and, for each good, product, or item of merchandise, the name or description of same, the store or stock keeping unit (SKU) number or information for or regarding same, the price of same, packaging information for or regarding same, number of units or quantity of same in a package offering, and/or any other data and/or information for or regarding each good, product, item of merchandise, or service, offered for sale by, or sold by, the distributor.

In a preferred embodiment, the database 40H can also contain and/or include, for the distributor, data and/or information regarding each user having an account with the distributor, each user account or each on-line shopping account each user has with the distributor, transaction history information regarding each user account, or each user on-line shopping account, and/or any of the data and/or information described herein as being stored for or regarding each user having an account with the distributor, each user account, each user on-line shopping account, and/or for each user, data and/or information regarding the user's order history or order histories, interests, purchasing habits, use habits, and/or goods, products, or merchandise, or services, which the user is likely to purchase or browse on-line, data and/or information regarding the user's past transaction shopping carts or transaction receipts, and/or data and/or information regarding saved shopping carts from previous shopping transactions engaged in by the user in a transaction(s) with the distributor, data and/or information regarding the user's shopping lists, habitual shopping lists, re-ordering lists, repeat purchasing lists, automatic re-ordering requests, and/or shopping habits, for or regarding any transactions with the distributor, any information regarding any order pick-up or delivery instructions and/or habits of the user, and/or any data and/or information regarding the user, any of member(s) of the user's family or household, any relative of the user, and/or any individual under the user's care or supervision, and/or any data and/or information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs/restrictions, for or regarding each user and/or each member of the user's family or household, each relative of the user, and/or each individual under the user's care or supervision, and/or any data and/or information regarding the user, any of member(s) of the user's family or household, any relative of the user, and/or any individual under the user's care or supervision, and/or any data and/or information regarding any clothing or footwear, or type(s), kind(s), style(s), or size(s), of same, for or regarding each user and/or each member of the user's family or household, each relative of the user, and/or each individual under the user's care or supervision, and/or any data and/or information regarding any of the user's distributor account(s), and/or any membership account(s), rewards account(s), club membership account(s), loyalty account(s), frequent customer account(s), discount membership account(s), repeat or regular customer account(s), and/or coupon account(s), which the user has with the distributor, and/or any data and/or information regarding a user's request or instruction to be provided with or to receive any and/or all of the alert messages or notification messages described herein which can be requested by, or provided to, the user, including, but not limited to, any of the herein-described coupon alerts, sales alerts, availability alerts, delivery alerts, order alerts, reorder alerts, new products alerts, and/or new services alerts.

In a preferred embodiment, the database 40H can also contain and/or include, for the distributor, any and/or all data and/or information regarding any pictures, photographs, video clips, video, video footage, and/or any other visual information or presentation, or digital visual presentation of any and/or all of the goods, products, or items of merchandise, offered for sale by the distributor, and/or as same are arranged, situated, or presented, in the distributor's brick and mortar store environment.

In a preferred embodiment, the database 40H can contain and/or include, a picture(s), photograph(s), or other video image(s), or other visual depiction(s), which can be taken, photographed, or recorded, and/or stored, of the physical display of any and/or all of the goods, products, or items of merchandise, as they are arranged, presented, or displayed, in or on the distributor's store aisles, store shelves, store racks, display stands, display racks, showcases, wall displays, point-of-sale displays, or any other type or kind of display, arrangement, or presentation, of any of the goods, products, or items of merchandise offered for sale by, or sold by, the distributor. In a preferred embodiment, any number of pictures, photographs, or other video images, or other visual depictions, can be photographed or recorded, and/or stored, and/or be can be linked together, for any and/or all or each type, kind, groups, or classification, of any goods, products, or items of merchandise, offered for sale by, or sold by, the distributor.

As and for an example, for cereals offered by a distributor, a picture or a series of pictures, or a photograph or a series of photographs, or a video clip or video footage, of the entire cereal aisle of the distributor can be taken, photographed, and/or recorded, and can be stored, so that a user, when buying cereal, can be provided with the picture or the series of pictures, or the photograph or the series of photographs, or the video clip or the video footage, of the entire cereal aisle so that the user can browse any and/or all of the various cereals offered by the distributor. In this same, similar, or analogous, manner, each and/or all of the various goods, products, or items of merchandise, offered for sale by, or sold by, the distributor can be photographed as they are arranged, offered, or presented, in the actual brick and mortar store environment of the distributor, whether they be arranged, presented, or situated on or in aisles, store shelves, store racks, display stands, display racks, showcases, wall displays, point-of-sale displays, or in or on any other type or kind of display, arrangement, or presentation. In a preferred embodiment, the database 40H can contain and/or include, for the distributor, any and/or all of the picture(s), series of pictures, photograph(s), series of photographs, video, video clips or video footage, or any other video image(s), or other visual depiction(s), of any and/or all of the various types or kinds of goods, products, or items of merchandise, offered for sale by, or sold by, the distributor.

In a preferred embodiment, the database 40H can also contain and/or include, for or regarding the distributor, any and/or all data and/or information regarding an index of all goods, products, or items of merchandise, the location of same in the distributor's store(s), such as but not limited to aisle number of aisle numbers, racks, shelves, display cases, displays, show cases, walls, points-of-sale, or other locations, where the respective goods, products, or items of merchandise, and/or where any clearance and/or discounted goods, products, or items of merchandise, are located, arranged, or presented, in the actual brick and mortar store or stores of the distributor, the prices of same, a description of same, any social networking information regarding same, any sales regarding same, any specials regarding same, any available coupons which are offered for same, and/or any other information which may be of interest to any user.

In a preferred embodiment, the database 40H can also contain or include, any and/or all desired or needed information regarding a respective good(s), product(s), or item(s) of merchandise sold by the distributor. As and for an example, in the case of a distributor which sells food and food products, that data and/or information for or regarding any good(s), product(s), or item(s) of merchandise, which is stored in the database 40H can include, for each and/or any and/or all food goods or food products, data and/or information regarding a food, including, but not limited to, its name, description, quantities/sizes available, nutritional content, nutritional information, caloric information, nutritional facts, dietary information, ingredients, percentage of daily requirements, price, expiration date, typical after purchase shelf life at home, and/or data and/or information regarding any types or kinds of recipes, recipe ingredients, instructions, video recipe tutorials, cooking tutorials, diet regimen tutorials, wellness tutorials, and/or fitness tutorials and/or requirements.

In a preferred embodiment, the database 40H can also contain and/or include, for or regarding the distributor, data and/or information regarding each distributor that provides goods, products, or merchandise, or services, to the distributor or to any of the distributor's customers.

In a preferred embodiment, the database 40H can also contain and/or include any and/or all of the herein-described merchandise group shopping page(s) of or associated with the distributor.

In a preferred embodiment, the database 40H can also contain and/or include any data and/or information regarding any of the herein-described user shopping events with the distributor, including, but not limited to, for each shopping event, the time, date, and/or duration, of the shopping event, any user's selection of any merchant or merchants or distributor or distributors in the shopping event, store index page(s) provided in the shopping event, selected merchandise group(s) in the shopping event, merchandise group shopping page(s) provided in the shopping event, shopping cart(s) or electronic shopping cart(s) and/or any contents of same for the shopping event whether or not an order was placed or a transaction was completed, any information processed by the central processing computer 10 during check-out in the shopping event, any information regarding any application of any and/or all discounts, member discounts, merchant member discounts, merchant club shopping discounts, merchant reward points, or sale prices, price reductions, or instant rebates, or any coupons, manufacturer coupons, store coupons, merchant coupons, distributor coupons, or any other coupons in the shopping event, any information regarding final order price for the shopping event, any information regarding the any method or mode of payment and/or any payment information and/or payment identifier information in the shopping event, or any information regarding and/or including ant transaction confirmation message for the shopping event or completed order message for the shopping event, and/or any and/or all information described herein regarding the shopping event or any contents of the user's shopping cart or electronic shopping cart when the user elected to exit the merchant's on-line store without making a purchase in or during the shopping event.

In a preferred embodiment, the database 40H can also contain and/or include and and/or all of the various types or kinds of alert messages or notification messages, or information regarding users' requests for same, including but not limited to, any of the herein-described alert messages or notification messages described herein as being generated by the apparatus 100 and/or the central processing computer 10 and transmitted to each user or to each user's respective communication device 50.

In a preferred embodiment, the database 40H can also contain and/or include any information regarding any social networks with which the distributor is a member or subscriber.

In a preferred embodiment, the database 40H can also contain and/or include, for each user having an account with the distributor, data and/or information regarding each distributor computer 40 which is or can be used by the respective distributor in utilizing the apparatus 100 and method of the present invention, including, but not limited to, data and/or information regarding an identification of each distributor computer 30, a description of, or type or kind of, same, the manufacturer, model number, and/or serial number, of same, or any other identification information, of, for, or regarding, same, and/or the assigned telephone number, e-mail address, text messaging or SMS messaging number, and/or IP address, or any network identification information, of, for, or associated with, same.

In a preferred embodiment, the database 40H can also contain and/or include, any other data and/or information and/or any link(s) or hyperlink(s) to same, described herein as being utilized in connection with the apparatus 100 and method of the present invention and/or in connection with the distributor computer 40.

In a preferred embodiment, the database 40H can also contain and/or include, any of the pictures, photographs, video clips, video recordings, video footage, tutorials, do-it-yourself tutorials, educational or training videos, recipes, or any other data and/or information described herein as being provided by the distributor, or which can be accessed from or via the distributor computer 40, and/or any link(s) or hyperlink(s) to same.

In a preferred embodiment, the database 40H can also contain and/or include, any data and/or information, news stories, news articles, market research reports, or any other information regarding clothing styles, fashion styles, fashion ensembles, fashion accessories, reports or reviews for or regarding goods, products, or items of merchandise, product recalls, available upgrades, safety alerts, and/or any other information which may be deemed useful to any user having an account with the distributor.

In a preferred embodiment, the database 40H can also contain and/or include data and/or information regarding manufacturing date(s), production date(s), manufacturing time(s), production time(s), manufacturing location, production location, manufacturing or production batch number, lot number, and/or any other information, for or regarding any of the goods, products, or merchandise, which can be offered for sale, or sold, by the distributor. In a preferred embodiment, any data and/or information regarding manufacturing date(s), production date(s), manufacturing time(s), production time(s), manufacturing location, production location, manufacturing or production batch number, lot number, and/or any other information, for or regarding any of the goods, products, or merchandise, can be utilized to document goods, products, or merchandise, purchased from the distributor and/or can also be utilized to provide an alert message(s) or a notification message(s) when a good, product, or item of merchandise, might be the subject of a recall of any type or kind.

In a preferred embodiment, the database 40H can also contain and/or include, any data and/or information, and/or software or software programs or software applications or “apps” for performing a language translation of any text or audio information from one language to another.

In a preferred embodiment, the database 40H can also contain and/or include, any data and/or information, and/or software or software programs or software applications or “apps” for allowing a user to access and/or interact with the distributor computer 40 with or via a cellular telephone, Smartphone, smart phone, personal digital assistant, tablet, tablet computer, and/or any other communication device 50 described herein as being utilized in connection with the apparatus 100 and method of the present invention, in a wireless communication environment or mobile communication environment.

In a preferred embodiment, the database 40H can also contain and/or include any data, information, software program(s), software, software application(s), or software “app” or “apps”, needed or desired for performing any of the operations, functions, and/or functionality, described herein as being performed by the distributor computer 40, the central processing computer 10 and/or the apparatus 100 of the present invention.

In a preferred embodiment, the database 40H can also contain and/or include any and/or all of the data and/or information described herein as being stored in the respective databases of any of the herein-described central processing computer(s) 10, server computer(s) 20, merchant computer(s) 30, and/or communication device(s) 50, and/or any other distributor computer(s) 40.

The distributor computer 40 also includes an output device 401, which is also connected to the CPU 40A, for outputting any data and/or information, described herein. In the preferred embodiment, the output device 401 can be a printer, a display, a transmitter, a modem, and/or any other device which can be used to output data or information.

The distributor computer 40 can also include a camera, and/or a video and/or audio recording device 40J which, in a preferred embodiment, can include a camera, a video recording device, a microphone, and/or an audio recording device. The video and/or audio recording device 40J can be utilized to take a picture, record video, record a video clip, record sound, record audio, or record an audio clip, which can be stored in the distributor computer 40 and, in particular, in the database 40H of the distributor computer 40 for use or uses consistent with the apparatus 100 and method of the present invention.

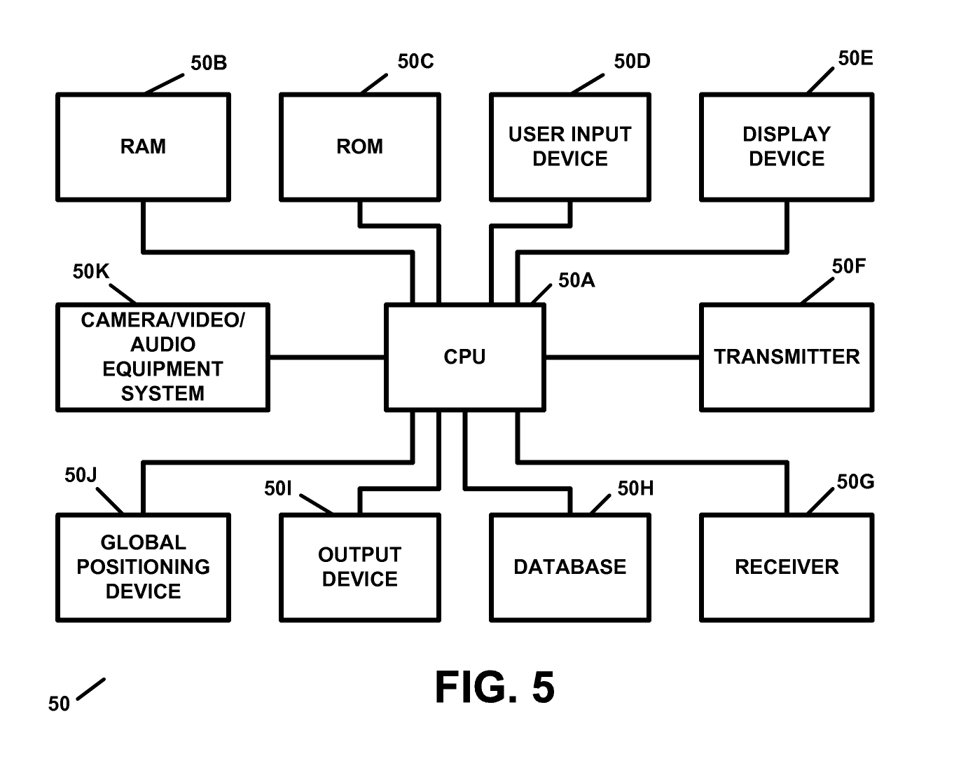

FIG. 5 illustrates the communication device 50 of FIG. 1, in block diagram form. With reference to FIG. 5, the communication device 50 includes a central processing unit or CPU 50A, which in the preferred embodiment, is a microprocessor. The CPU 50A may also be a microcomputer, a minicomputer, a macro-computer, and/or a mainframe computer, depending upon the application.

With reference to FIG. 5, the communication device 50 also includes a random access memory device(s) 50B (RAM) and a read only memory device(s) 50C (ROM), each of which is connected to the CPU 50A, and a user input device 50D, for entering data, information, and/or commands, into the communication device 50, which includes any one or more of a keyboard, a scanner, a touch screen, a user pointing device, such as, for example, a mouse, a touch pad, a touch screen, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus 100 of the present invention, into the communication device 50. The input device 50D can also be any other input device(s) which are or can be utilized with or in connection with any of the communication devices 50 described herein as being utilized in connection with the apparatus 100 of the present invention. The input devices 50D are also connected to or with, or linked to or with, the CPU 50A. In a preferred embodiment, the input device 50 can also include a retinal scanner, a fingerprint recognition device, a voice recognition device, or any other type or kind of biometric device which can be used for determining whether or not a user or operator of the communication device 50 is an authorized user, individual, or person.

The communication device 50 also includes a display device 50E for displaying data and/or information to a user or operator.

The communication device 50 also includes a transmitter(s) 50F, for transmitting signals and/or data and/or information, or a message(s), to any one or more of the central processing computer(s) 10, the server computer(s) 20, the merchant computer(s) 30, the distributor computer(s) 40, and/or to any other communication device(s) 50, described herein.

The communication device 50 also includes a receiver(s) 50G, for receiving signals and/or data and/or information from any one or more of the central processing computer(s) 10, the server computer(s) 20, the merchant computer(s) 30, the distributor computer(s) 40, and/or from any other communication device(s) 50, described herein.

The communication device 50 also includes a database(s) 50H, which is also connected to or linked with the CPU 50A, which can contain and/or include any and/or all of the data and/or information needed or desired for performing any and/or all of the functions and/or functionality described herein as being performed by the communication device 50 and/or the apparatus 100 and method of the present invention.

The communication device also includes a database(s) 50H, which is also connected to or linked with the CPU 50A, which can contain and/or include any and/or all of the data and/or information needed or desired for performing any and/or all of the functions and/or functionality described herein as being performed by the communication device 50, the central processing computer 10, and/or the apparatus 100 and method of the present invention.

In a preferred embodiment, the database 50H contains and/or includes data and/or information regarding the user of the communication device 50, and/or any data and/or information regarding any of the herein-described merchants with whom or which the user has an account, and/or including, for each merchant, any and/or all of the respective goods, products, or merchandise, or respective services, offered for sale by, or sold by, each merchant, and/or any data and/or information regarding any of the herein-described distributors with whom or which the user has an account, and/or including, for each distributor, any and/or all of the respective goods, products, or merchandise, or respective services, offered for sale by, sold by, or distributed by, each distributor.

In a preferred embodiment, the database 50H can contain and/or include, for each user of the communication device 50, each user's name, sign-in name or sign in information, password, address, billing address, shipping address, credit/charge debit number, bank account, saving account, checking, electronic money account, or any data and/or information regarding any other kind or type of payment identifier utilized by the user in transaction.

In a preferred embodiment, the database 50H can also contain and/or include, for each user of the communication device 50, information regarding each user's on-line shopping account(s) with the apparatus 100, with the central processing computer 10, or with each merchant or distributor with who or with the user has an on-line shopping account, which on-line shopping account can be utilized by the user to engage in on-line shopping transactions and/or Internet shopping transactions with the respective merchant or distributor.

In a preferred embodiment, the database 50H can contain and/or include, for each user of the communication device 50, data and/or information regarding the user's gender, age, demographics, race, religion, nationality, education level or education information, occupation, employment information, information regarding the user's employer, and/or information regarding any members of the user's household or family, and/or social networking friends, followers, or other individuals.

In a preferred embodiment, the database 50H can also contain and/or include data and/or information regarding any account(s) which a user of the communication device 50 has established with, or which exists with, any of the herein-described merchants and/or distributors, data and/or information regarding any transactions, or on-line shopping event(s) or occurrence(s), which the user has engaged in with each merchant and/or distributor, data and/or information regarding, for each transaction or on-line event engaged in between the user with a merchant and/or distributor, data and/or information regarding goods, products, or merchandise, or services, purchased or browsed, data and/or information regarding any transaction histories for the user with each merchant and/or distributor, and/or data and/or information regarding goods, products, or merchandise, or services, purchased by or browsed by the user with each merchant and/or distributor.

In a preferred embodiment, the database 50H can also contain and/or include, for each user of the communication device 50, data and/or information regarding the user's order history or order histories, interests, purchasing habits, use habits, and/or goods, products, or merchandise, or services, which the user is likely to purchase or browse on-line, data and/or information regarding the user's past transaction shopping carts or transaction receipts, and/or data and/or information regarding saved shopping carts from previous shopping transactions engaged in by the user in a transaction with any merchant(s) and/or distributor(s).

In a preferred embodiment, the database 50H can also contain and/or include, for each user of the communication device 50, data and/or information regarding the user's shopping lists, habitual shopping lists, re-ordering lists, repeat purchasing lists, automatic re-ordering requests, and/or shopping habits, for or regarding any transactions with any merchants and/or distributors.

In a preferred embodiment, the database 50H can also contain and/or include, for each user of the communication device 50, any information regarding any order pick-up or delivery instructions and/or habits of the user.

In a preferred embodiment, the database 50H can also contain and/or include, for the user of the communication device 50, any data and/or information regarding the user, any of member(s) of the user's family or household, any relative of the user, and/or any individual under the user's care or supervision, and/or any data and/or information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs, and/or fitness restrictions, for or regarding the user and/or each member of the user's family or household, each relative of the user, and/or each individual under the user's care or supervision.

In a preferred embodiment, the database 50H can also contain and/or include, for the user of the communication device 50, any member(s) of the user's family or household, any relative of the user, and/or any individual under the user's care or supervision, any data and/or information regarding any healthcare insurance or wellness incentives or programs for or associated with the user, the member(s) of the user's family or household, the relative of the user, and/or any individual under the user's care or supervision.

In a preferred embodiment, the database 50H can also contain and/or include, for the user of the communication device 50, any data and/or information regarding the user, any of member(s) of the user's family or household, any relative of the user, and/or any individual under the user's care or supervision, and/or any data and/or information regarding any clothing or footwear, including, but not limited to size(s), type(s), kind(s), or style(s), for or regarding the user and/or each member of the user's family or household, each relative of the user, and/or each individual under the user's care or supervision.

In a preferred embodiment, the database 50H can also contain and/or include, for the user of the communication device 50, any data and/or information regarding any of the user's merchant account(s), and/or distributor account(s), and/or any membership account(s), rewards account(s), club membership account(s), loyalty account(s), frequent customer account(s), discount membership account(s), repeat or regular customer account(s), and/or coupon account(s), which the user has with each merchant or distributor.

In a preferred embodiment, the database 50H can also contain and/or include any coupons, electronic coupons, digital coupons, certificates or other suitable items evidencing a rebate or rebates, or rewards points or rewards currency, which are issued by any merchant(s) or distributor(s) who or which utilizes the apparatus 100 and method of the present invention. In a preferred embodiment, each merchant can automatically apply any coupon(s), rebate(s), or reward(s) to a transaction, thereby dispensing with the need for the user to have to find, locate, handle, and/or apply, a coupon(s), rebate information, or rewards information, when making an on-line purchase from a merchant. In a preferred embodiment, each distributor conducting a transaction directly with the user can also automatically apply any coupon(s) to a transaction, thereby dispensing with the need for the user to have to find, locate, handle, and/or apply, a coupon(s) when making an on-line purchase from directly from a distributor.

In a preferred embodiment, the database 50H can also include any data and/or information, associated with any good, product, or item of merchandise, which can be utilized in order to automatically establish a marketing account, a membership account, a club membership account, a loyalty account, a rebate account, or a discount account, or any other account establishing a relationship, a marketing relationship, or a direct marketing relationship, with and between the user and any merchant and/or any distributor upon the user purchasing a good, product, or item of merchandise, from a merchant, from a distributor, or from a merchant and/or which is or provided or distributed by a distributor.

In a preferred embodiment, the database 50H can also contain and/or include any and/or all of the herein-described merchandise group shopping page(s) of or associated with each merchant or each distributor with who or which the user of the communication device 50 has an account or shops.

In a preferred embodiment, the database 50H can also contain and/or include any data and/or information regarding any of the herein-described user shopping events involving any user who utilizes the communication device 50, including, but not limited to, for each shopping event, the time, date, and/or duration, of the shopping event, any user's selection of any merchant or merchants or distributor or distributors in the shopping event, store index page(s) provided in the shopping event, selected merchandise group(s) in the shopping event, merchandise group shopping page(s) provided in the shopping event, shopping cart(s) or electronic shopping cart(s) and/or any contents of same for the shopping event whether or not an order was placed or a transaction was completed, any information processed by the central processing computer 10 during check-out in the shopping event, any information regarding any application of any and/or all discounts, member discounts, merchant member discounts, merchant club shopping discounts, merchant reward points, or sale prices, price reductions, or instant rebates, or any coupons, manufacturer coupons, store coupons, merchant coupons, distributor coupons, or any other coupons in the shopping event, any information regarding final order price for the shopping event, any information regarding the any method or mode of payment and/or any payment information and/or payment identifier information in the shopping event, or any information regarding and/or including ant transaction confirmation message for the shopping event or completed order message for the shopping event, and/or any and/or all information described herein regarding the shopping event or any contents of the user's shopping cart or electronic shopping cart when the user elected to exit the merchant's on-line store without making a purchase in or during the shopping event.

In a preferred embodiment, the database 50H can also contain or include, for each user of the communication device 50, any data and/or information regarding the user's request or instruction to be provided with or to receive alert messages or notification messages, via a e-mail message, a text message, pre-recorded telephone message, or via any other type, kind, or mode of communication, from the apparatus 100, from the central processing computer 10, or from any merchant computer 30 and/or distributor computer 40, which alert message or notification message can serve to alert or notify the user regarding any transaction involving any of the user's on-line shopping account(s) with the apparatus 100, or the central processing computer 10, or with any merchant or distributor.

In a preferred embodiment, the database 50H can also contain or include, for each user of the communication device 50, any data and/or information regarding the user's request or instruction to be provided with or to receive alert messages or notification messages, containing information regarding the availability or issuance of coupons by a merchant, a distributor, the central processing computer 10, or the apparatus 100 (hereinafter “coupon alerts”), or containing information regarding sales or specials regarding any goods, products, or merchandise, or services, offered by a merchant or distributor, which can be purchased via the apparatus 100 of the present invention (hereinafter “sales alerts”), or containing information regarding the availability or the delivery of any goods, products, or merchandise at or to, or the availability of services at or from, a merchant or distributor (hereinafter “availability alerts” or “delivery alerts”), or containing information reminding a user or a time to order or to reorder certain goods, products, or merchandise, or services (hereinafter “order alerts” or “reorder alerts”), or containing information regarding the introduction or availability of new goods, products, or merchandise, or services, for purchase from or at (hereinafter “new products alerts” or “new services alerts”) a merchant or distributor.

In a preferred embodiment, the database 50H can also contain or include, for each user of the communication device 50, or for each member of each user's household, family, or defined friend of family group, data and/or information regarding the social network or social networks in which the user and/or each member of each user's household, family, or defined friend of family group, belongs.

In a preferred embodiment, the database 50H can also contain and/or include, for each user of the communication device 50, data and/or information regarding each communication device 50 which is or can be used by the user in utilizing the apparatus 100 and method of the present invention, including, but not limited to, data and/or information regarding an identification of each communication device 50, a description of, or type or kind of, the communication device 50, manufacturer, model number, and/or serial number or any other identification information, of, for, or regarding, the communication device 50, and/or the assigned telephone number, e-mail address, text messaging or SMS messaging number, and/or IP address, or any network identification information, of, for, or associated with, the communication device 50.

In a preferred embodiment, the database 50H can also contain and/or include, for each user of the communication device 50, data and/or information regarding any language or languages in which the user desires to receive or obtain any of the text information or audio information, or any other information, described herein as being provided by the apparatus 100 of the present invention, or the language or languages in which the user desires to use the apparatus 100 of the present invention.

In a preferred embodiment, the database 50H can also contain and/or include, for each merchant and for each distributor with whom the user has an account, any and/or all data and/or information regarding the name, address, website, telephone number, e-mail address, and/or any other contact information for or regarding the respective merchant or distributor.

In a preferred embodiment, the database 50H can also contain and/or include, for each merchant and for each distributor with whom the user has an account, any and/or all data and/or information regarding any and/or all of the goods, products, or merchandise, or services, offered for sale by, or sold by, the respective merchant or distributor and, for each good, product, or item of merchandise, the name or description of same, the store or stock keeping unit (SKU) number or information for or regarding same, the price of same, packaging information for or regarding same, number of units or quantity of same in a package offering, and/or any other data and/or information for or regarding each good, product, item of merchandise, or service, offered for sale by, or sold by, the respective merchant or distributor.

In a preferred embodiment, the database 50H can also contain and/or include, for each merchant and for each distributor with whom the user has an account, data and/or information regarding each user account or each on-line shopping account the user has with the respective merchant or distributor, transaction history information regarding each user account or each user on-line shopping account, and/or any of the data and/or information described herein as being stored for or regarding the user, each user account or each user on-line shopping account, and/or for each user account, data and/or information regarding the user's order history or order histories, interests, purchasing habits, use habits, and/or goods, products, or merchandise, or services, which the user is likely to purchase or browse on-line, data and/or information regarding the user's past transaction shopping carts or transaction receipts, and/or data and/or information regarding saved shopping carts from previous shopping transactions engaged in by the user in transactions with the respective merchant or distributor, data and/or information regarding the user's shopping lists, habitual shopping lists, re-ordering lists, repeat purchasing lists, automatic re-ordering requests, and/or shopping habits, for or regarding any transactions with the respective merchant or distributor, any information regarding any order pick-up or delivery instructions and/or habits of the user, and/or any data and/or information regarding the user, any of member(s) of the user's family or household, any relative of the user, and/or any individual under the user's care or supervision, and/or any data and/or information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs/restrictions, for or regarding the user and/or each member of the user's family or household, each relative of the user, and/or each individual under the user's care or supervision, and/or any data and/or information regarding the user, any of member(s) of the user's family or household, any relative of the user, and/or any individual under the user's care or supervision, and/or any data and/or information regarding any clothing or footwear, or type(s), kind(s), style(s), or size(s), of same, for or regarding the user and/or each member of the user's family or household, each relative of the user, and/or each individual under the user's care or supervision, and/or any data and/or information regarding any of the user's merchant account(s), and/or distributor account(s), and/or any membership account(s), rewards account(s), club membership account(s), loyalty account(s), frequent customer account(s), discount membership account(s), repeat or regular customer account(s), and/or coupon account(s), which the user has with the merchant or distributor, and/or any data and/or information regarding a user's request or instruction to be provided with, or to receive, any and/or all of the alert messages or notification messages described herein which can be requested by, or provided to, the user, including, but not limited to, any of the herein-described coupon alerts, sales alerts, availability alerts, delivery alerts, order alerts, reorder alerts, new products alerts, and/or new services alerts.

In a preferred embodiment, the database 50H can also contain and/or include, for each merchant and for each distributor with whom the user has an account, any and/or all data and/or information regarding any pictures, photographs, video clips, video, video footage, and/or any other visual information or presentation, or digital visual presentation of any and/or all of the goods, products, or items of merchandise, offered for sale by the respective merchant or distributor, as same are arranged in the brick and mortar store environment of the merchant and/or the distributor.

In a preferred embodiment, the database 50H can contain and/or include, a picture(s), photograph(s), or other video image(s), or other visual depiction(s), which can be taken, photographed, or recorded, and/or stored, of the physical display of any and/or all of the goods, products, or items of merchandise, as they are arranged, presented, or displayed, in or on each merchant's or distributor's store aisles, store shelves, store racks, display stands, display racks, showcases, wall displays, point-of-sale displays, or any other type or kind of display, arrangement, or presentation, of any of the goods, products, or items of merchandise offered for sale by, or sold by, the respective merchant or distributor. In a preferred embodiment, any number of pictures, photographs, or other video images, or other visual depictions, can be photographed or recorded, and/or stored, and/or be can be linked together, for any and/or all or each type, kind, groups, or classification, of any goods, products, or items of merchandise, offered for sale by, or sold by, the respective merchant or distributor.

As and for an example, for cereals offered by a supermarket merchant, a picture or a series of pictures, or a photograph or a series of photographs, or a video clip or video footage, of the entire cereal aisle of the supermarket merchant can be taken, photographed, and/or recorded, and can be stored, so that a user, when buying cereal, can be provided with the picture or the series of pictures, or the photograph or the series of photographs, or the video clip or the video footage, of the entire cereal aisle so that the user can browse any and/or all of the various cereals offered by the supermarket merchant. In this same, similar, or analogous, manner, each and/or all of the various goods, products, or items of merchandise, offered for sale by, or sold by, the respective merchant or distributor can be photographed as they are arranged, offered, or presented, in the actual brick and mortar store environment, whether they be arranged, presented, or situated on or in aisles, store shelves, store racks, display stands, display racks, showcases, wall displays, point-of-sale displays, or in or on any other type or kind of display, arrangement, or presentation. In a preferred embodiment, the database 50H can contain and/or include, for each respective merchant or distributor with whom the user has an account, any and/or all of the picture(s), series of pictures, photograph(s), series of photographs, video, video clips or video footage, or any other video image(s), or other visual depiction(s), of any and/or all of the various types or kinds of goods, products, or items of merchandise, offered for sale by, or sold by, the respective merchant or distributor.

In a preferred embodiment, the database 50H can also contain and/or include, for each respective merchant or distributor with whom the user has an account, any and/or all data and/or information regarding an index of all goods, products, or items of merchandise, the location of same in the merchant's store or stores or the distributor's store or stores, such as, but not limited to, aisle number of aisle numbers, racks, shelves, display cases, displays, show cases, walls, points-of-sale, or other location, where the respective goods, products, or items of merchandise, and/or where any clearance and/or discounted goods, products, or items of merchandise, are located, arranged, or presented, in the actual brick and mortar store or stores of the merchant or the distributor, the prices of same, a description of same, any social networking information regarding same, any sales regarding same, any specials regarding same, any available coupons which are offered for same, and/or any other information which may be of interest to any user.

In a preferred embodiment, the database 50H can also contain or include, any and/or all desired or needed information regarding a respective good(s), product(s), or item(s) of merchandise, sold by any merchant or distributor with whom the user has an account. As and for an example, in the case of a supermarket merchant which sells food and food products, that data and/or information for or regarding any good(s), product(s), or item(s) of merchandise, which is stored in the database 50H can include, for each and/or any and/or all food goods or food products, data and/or information regarding a food, including, but not limited to, its name, description, quantities/sizes available, nutritional content, nutritional information, caloric information, nutritional facts, dietary information, ingredients, percentage of daily requirements, price, expiration date, typical after purchase shelf life at home and/or data and/or information regarding any types or kinds of recipes, recipe ingredients, instructions, video recipe tutorials, cooking tutorials, diet regimen tutorials, wellness tutorials, and/or fitness tutorials and/or requirements.

In a preferred embodiment, the database 50H can also contain and/or include, for each merchant with whom the user has an account, data and/or information regarding each distributor that provides goods, products, or merchandise, or services, to each merchant or to any of the merchant's customers. In a preferred embodiment, the database 50H can also contain and/or include, for each distributor with whom the user has an account, data and/or information regarding each merchant that is supplied by or serviced by each distributor.

In a preferred embodiment, the database 50H can also contain and/or include any and/or all of the various types or kinds of user requested alert messages or notification messages which were transmitted to or provided to the communication device 50, or any information regarding the users' requests for same, including but not limited to, any of the herein-described alert messages or notification messages described herein as being generated by the apparatus 100 and/or the central processing computer 10 and transmitted to the user or to each of the user's respective communication devices 50.

In a preferred embodiment, the database 50H can also contain and/or include any information regarding any social networks with which the respective user is a member or subscriber.

In a preferred embodiment, the database 50H can also contain and/or include, for each user who uses the communication device 50, data and/or information regarding each communication device 50 which is or can be used by the user in utilizing the apparatus 100 and method of the present invention, including, but not limited to, data and/or information regarding an identification of each communication device 50, a description of, or type or kind of, same, the manufacturer, model number, and/or serial number, of same, or any other identification information, of, for, or regarding, same, and/or the assigned telephone number, e-mail address, text messaging or SMS messaging number, and/or IP address, or any network identification information, of, for, or associated with, same.

In a preferred embodiment, the database 50H can also contain and/or include, any other data and/or information and/or any link(s) or hyperlink(s) to same, described herein as being utilized in connection with the apparatus 100 and method of the present invention.

In a preferred embodiment, the database 50H can also contain and/or include, any of the pictures, photographs, video clips, video recordings, video footage, tutorials, do-it-yourself tutorials, educational or training videos, recipes, or any other data and/or information described herein as being provided to a user by, or which can be accessed by or via, the communication device 50 and/or any link(s) or hyperlink(s) to same.

In a preferred embodiment, the database 50H can also contain and/or include, any data and/or information, news stories, news articles, market research reports, or any other information regarding clothing styles, fashion styles, fashion ensembles, fashion accessories, reports or reviews for or regarding goods, products, or items of merchandise, product recalls, available upgrades, safety alerts, and/or any other information which may be deemed useful to the user of the communication device 50.

In a preferred embodiment, the database 50H can also contain and/or include data and/or information regarding manufacturing date(s), production date(s), manufacturing time(s), production time(s), manufacturing location, production location, manufacturing or production batch number, lot number, and/or any other information, for or regarding any of the goods, products, or merchandise, which can be offered for sale, or sold, via the present invention. In a preferred embodiment, any data and/or information regarding manufacturing date(s), production date(s), manufacturing time(s), production time(s), manufacturing location, production location, manufacturing or production batch number, lot number, and/or any other information, for or regarding any of the goods, products, or merchandise, can be utilized to document goods, products, or merchandise, purchased by and user and/or can also be utilized to provide an alert message or a notification message(s) when a good, product, or item of merchandise, might be the subject of a recall of any type or kind.

In a preferred embodiment, the database 50H can also contain and/or include, any data and/or information, and/or any software or software programs, or software applications or “apps”, for enabling the user of the communication device 50 to shop at or with more than one merchant during a same shopping event or shopping sitting with the apparatus 100 and method of the present invention. In a preferred embodiment, the communication device 50 can be utilized so as to allow the user to also shop with more that one merchant using a split screen shopping format(s).

In a preferred embodiment, the database 50H can also contain and/or include, any data and/or information, and/or software or software programs or software applications or “apps” for performing a language translation of any text or audio information from one language to another.

In a preferred embodiment, the database 50H can also contain and/or include, any data and/or information, and/or software or software programs or software applications or “apps” for allowing the user of the communication device 50 to utilize the apparatus 100 and method of the present invention in connection with or via a cellular telephone, Smartphone, smart phone, personal digital assistant, tablet, tablet computer, and/or any other communication device 50 described herein as being utilized in connection with the apparatus 100 and method of the present invention, in a wireless communication environment or mobile communication environment.

In a preferred embodiment, the database 50H can also contain and/or include any data, information, software program(s), software, software application(s), or software “app” or “apps”, needed or desired for performing any of the operations, functions, and/or functionality, described herein as being performed by the communication device 50.

In a preferred embodiment, the database 50H can also contain and/or include any and/or all of the data and/or information described herein as being stored in the respective databases of any of the herein-described central processing computer(s) 10, server computer(s), merchant computer(s) 30, distributor computer(s) 40, and/or any other communication device(s) 50.

In a preferred embodiment, the database 50H can also contain or include any data and/or information needed or desired for performing any and all of the processing routines, functions, and/or functionality, described herein as being performed by the communication device 50 and/or the apparatus 100 of the present invention.

The communication device 50 also includes an output device 501, which is also connected to the CPU 50A, for outputting any data and/or information, described herein. In the preferred embodiment, the output device 501 can be a printer, a display, a transmitter, a modem, and/or any other device which can be used to output data or information.

The communication device 50 can also be equipped with a global positioning device 50J which can be connected to the CPU 50A and which can be utilized to calculate, determine, or ascertain, the position or location of the communication device 50.

The communication device 50 can also include a video and/or audio recording device 50K which, in a preferred embodiment, can include a camera, a video recording device, a microphone, and/or an audio recording device. The video and/or audio recording device 50K can be utilized to take a picture, record video, record a video clip, record sound, record audio, or record an audio clip, of a user of the communication device 50 and/or to record any picture, a sound or voice, video information, or audio information, which can be stored in the distributor computer 40 and, in particular, in the database 50H of the communication device 50 for use or uses consistent with the apparatus 100 and method of the present invention.

The apparatus 100 and method of the present invention can be utilized in a number of preferred embodiments in order to allow any of the herein-described users to engage in on-line shopping and/or Internet shopping with any of the herein-described merchants and/or distributors. The apparatus 100 of the present invention, in a preferred embodiment, can be utilized in order to shop on-line and/or via the Internet by viewing actual in-store pictures, photographs, video, video clips, or video footage, of the various goods, products, or merchandise, offered by a merchant and/or a distributor, as same are arranged, displayed, situated, or presented, in or on store aisles, store shelves, store racks, display stands, display racks, showcases, wall displays, point-of-sale displays, or any other type or kind of display, arrangement, or presentation, of any of the goods, products, or merchandise offered for sale by, or sold by, the respective merchant or distributor.

In a preferred embodiment, any number of pictures, photographs, or other video images, or other visual depictions, can be photographed or recorded, and/or stored, and/or be can be linked together, for any and/or all or each type, kind, groups, or classification, of any goods, products, or merchandise, offered for sale by, or sold by, the respective merchant or distributor. In a preferred embodiment, any of the data and/or information described herein as being utilized, stored, provided by, and/or processed by, any central processing computer(s) 10, server computer(s) 20, merchant computer(s) 30, distributor computer(s) 40, or communication device(s) 50, can be updated at any time and/or automatically.

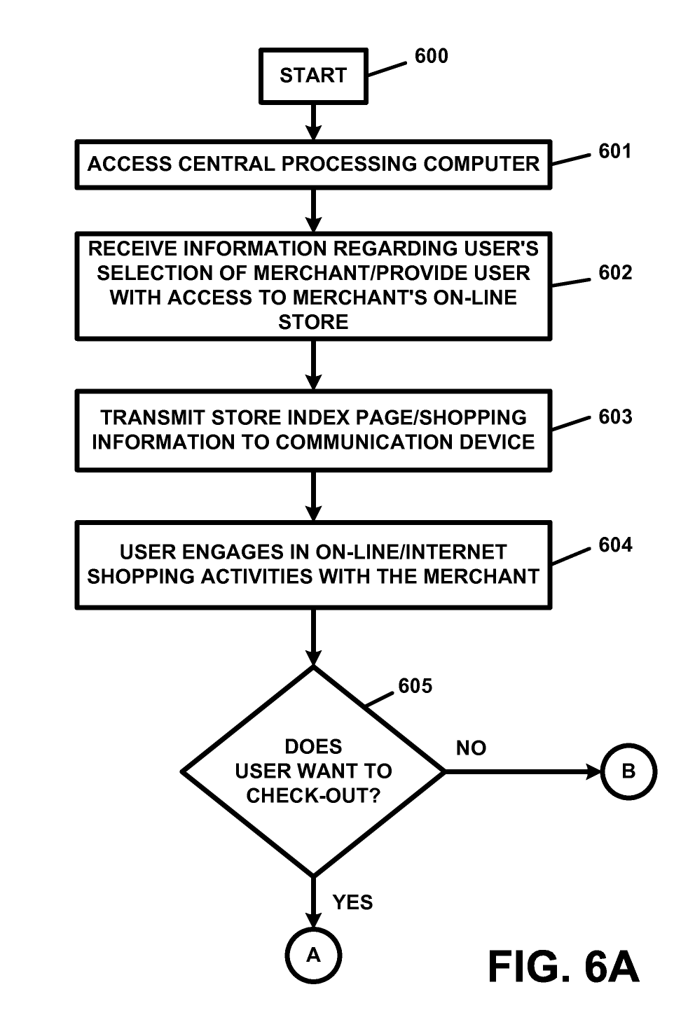

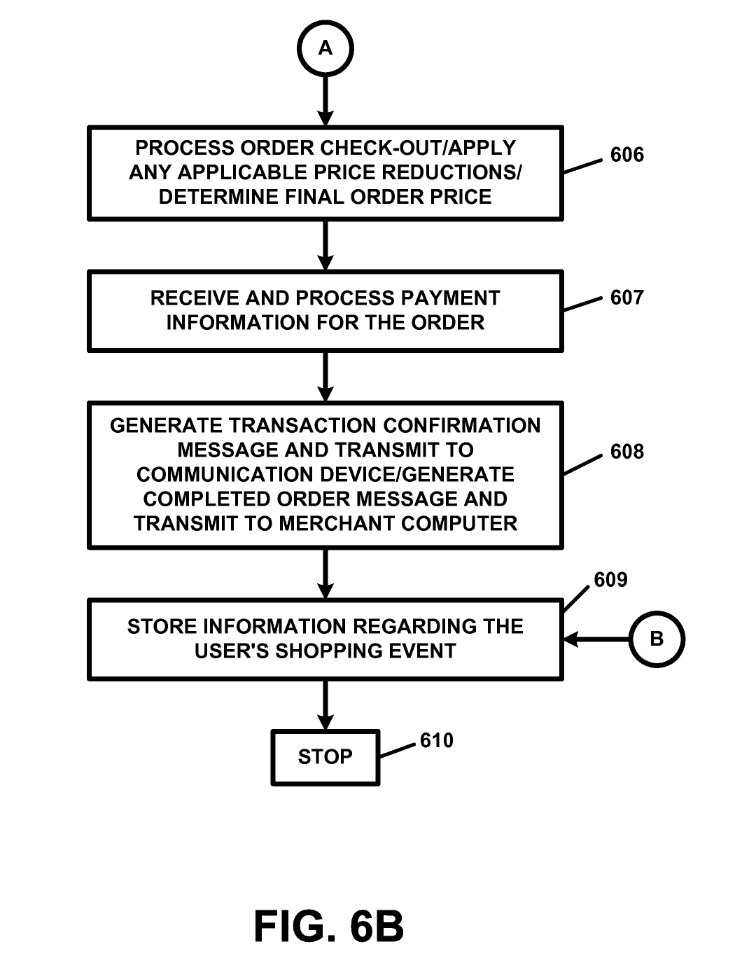

FIGS. 6A and 6B illustrate a preferred embodiment method for using the apparatus 100 and method of the present invention, in flow diagram form. The preferred embodiment method of FIGS. 6A and 6B will be described herein as involving a user engaging in food or grocery shopping on-line and/or via the Internet. It is important to note, however, that the method of FIGS. 6A and 6B can also be utilized in a same, a similar, and/or an analogous, manner, in order to shop on-line and/or via the Internet, for any type or kind of goods, products, or merchandise, with any merchants, whether described herein or otherwise, and/or with any type of kind of distributor.

With reference to FIGS. 6A and 6B, the operation of the apparatus 100 commences at step 600. At step 601, the user can access the central processing computer 10 by using the communication device 50. In a preferred embodiment, the central processing computer 10 can be associated with, and can facilitate on-line shopping and/or Internet shopping with, any number of merchants and/or with any number of distributors. In another preferred embodiment, the central processing computer 10 can also be dedicated to facilitating on-line shopping and/or Internet shopping with only a single merchant or a single distributor. At step 601, the user can also enter, and transmit to the central processing computer 10, any identifying information and/or security information for accessing his or her shopping account with the central processing computer 10.

At step 602, the user can select the merchant with which he or she wants to shop with during the on-line shopping and/or Internet shopping event (hereafter “shopping event”). At step 602, any data and/or information regarding the user's selection of a merchant can be entered into the communication device 50 and can be transmitted to, and received by, the central processing computer 10. At step 602, the central processing computer 10 can process the data and/or information received at step 602, and can provide the user with access to the merchant's on-line store. Thereafter, the operation of the apparatus 100 will proceed to step 603.

At step 603, the user can commence shopping with the merchant. In a preferred embodiment, the central processing computer 10 can provide and/or can transmit to the communication device 50 a store index page which can contain data and/or information regarding an index of the various goods, products, or merchandise, offered for sale by, or sold by, the merchant, along with any information regarding or identifying the aisle number of the aisle, or information regarding or identifying the store shelf, rack, display stand, display rack, showcase, wall display, point-of-sale display, or other display, arrangement, or presentation, or the location of same, in the merchant's brick and mortar store where the respective goods, products, or merchandise, are located.

At step 604, the user can commence shopping with the merchant and can engage in on-line and/or Internet shopping activities with the merchant and/or the user can commence placing and place an order for any good(s), product(s), or merchandise, with the merchant. At step 604, the user can select the good(s), product(s), or merchandise (hereinafter “the selected merchandise group”), which he or she desires to shop for or purchase, from the store index page and the user communication device 50 can transmit data and/or information regarding the user's selection of the selected merchandise group to the central processing computer 10. As and for an example, a user looking to purchase cereal can select “cereal” as the selected merchandise group. The central processing computer 10 will receive and process the information regarding the selected merchandise group and, in response thereto, transmit, for the selected merchandise group, a merchandise group shopping page to the communication device 50.

In a preferred embodiment, the merchandise group shopping page can include, for the selected merchandise group, a photograph(s), picture(s), video, or video image(s), of the merchant's actual brick and mortar store offering, assortment, and/or arrangement, of any and/or all of the goods, products, or merchandise, which comprise the merchant's in-store selection for that selected merchandise group. For example, in a preferred embodiment, the merchandise group shopping page can include, for the selected merchandise group, a photograph(s), picture(s), or video image(s), of the aisle(s), store shelf or shelves, rack(s), display stand(s), display rack(s), showcase(s), wall display(s), point-of-sale display(s), or other display(s), arrangement(s), or presentation(s), of the merchant's actual brick and mortar store offering, assortment, and/or arrangement, of any and/or all of the goods, products, or merchandise, which comprise the merchant's in-store selection for that selected merchandise group. For example, for the user's selection of cereal, the merchandise group shopping page for the merchant's cereal offerings can include a photograph(s), picture(s), or video image(s), of the merchant's cereal aisle(s), store shelf or shelves, rack(s), display stand(s), display rack(s), showcase(s), wall display(s), point-of-sale display(s), or other display(s), arrangement(s), or presentation(s).

In a preferred embodiment, the merchandise shopping group page can include, in the photograph(s), picture(s), video, or video image(s), provided, the merchant's complete, or nearly complete, offering of goods, products, or merchandise in the selected merchandise shopping group. In a preferred embodiment, the merchant's complete, or nearly complete, offering of goods, products, or merchandise in the selected merchandise shopping group, can be provided in a single photograph or in any number, or a grouping of, photographs which can be linked or provided in a sequence, in a single picture or in any number, or a grouping of, group of pictures which can be linked or provided in a sequence, or in a video, video clip, or video footage, which can be linked or provided in a sequence.

In a preferred embodiment, the merchandise shopping group page can also include, for display along with or in conjunction with the photograph(s), picture(s), video, or video image(s), of the selected merchandise group, information regarding or identifying each of the different brands, types, or kinds, of the items of merchandise, or each good or product, in the selected merchandise group offered by the merchant in the merchant's brick and mortar store.

In a preferred embodiment, in instances in which the merchant's offerings in the selected merchandise group are provided in more than a single photograph, picture, video, or video image, the merchandise shopping group page can provide or display the information regarding or identifying each of the different brands, types, or kinds, of the items of merchandise, or each good or product, in the selected merchandise group which are offered by the merchant at all times regardless of whether or not a particular item of merchandise, good, or product, is depicted in any single photograph, picture, video, or video image, at any given time, thereby providing the user with information regarding the merchant's complete offering while viewing each photograph, picture, video, or video image. In another preferred embodiment, the merchandise shopping group page can also provide or display the information regarding or identifying each of the different brands, types, or kinds, of the items of merchandise, or each good or product, actually depicted in a displayed photograph, picture, video, or video image.

In a preferred embodiment, any information regarding or identifying each of the different brands, types, or kinds, of the items of merchandise, or each good or product, in the selected merchandise group, can include, for each item of merchandise, good, or product listed, information regarding the name or brand of the respective item or merchandise, good, or product, a description of same, the price of same, or a sale, promotion, or clearance, regarding same, and/or a link to an information page containing information regarding the respective item or merchandise, good, or product, and/or in the case of a sale, the regular price of same and the sale price of same, and/or information regarding the size or quantity of same, if applicable, and/or whether or not a store coupon or a manufacturer coupon or distributor coupon, or whether any rebate, whether the rebate be a mail-in rebate or an instant rebate received at check-out, is offered or available for same, and/or any other information regarding the respective item or merchandise, good, or product, which may be of interest the user or to a consumer.

At step 604, the user can use the merchandise shopping group page, and any photograph(s), picture(s), video, or video image(s), and/or information contained therein, to shop for any good(s), product(s), or merchandise, offered by the merchant in the selected merchandise group. In instances when the user desires to purchase any good(s), product(s), or merchandise, offered by the merchant in the selected merchandise group, he or she can add same, along with any quantity or quantities of same, to his or her shopping cart or electronic shopping cart, or the user can elect to make no purchase in or from the selected merchandise group.

Thereafter, at step 604, the user can either continue shopping on or from the provided merchandise group shopping page for the selected merchandise group, or the user can exit same, navigate to the store index page in order to select another merchandise group (‘the next merchandise group”) for continued shopping in that next merchandise group, or the user can elect to check-out and place his or her order with merchant.

In a preferred embodiment, the user, at step 604, can repeat the above-described process, until his or her shopping with the merchant is completed, in order to select any number of merchandise groups from which to shop one at a time, obtain a respective merchandise shopping group page for that selected merchandise group, and utilize the respective merchandise shopping group page in order to shop for, purchase, or not purchase, any good(s), product(s), or merchandise, on or from the respective merchandise shopping group page.

In a preferred embodiment, at step 604, the user can also request, and can be provided with, for use while shopping in or during the shopping event, any data and/or information regarding any of the user's shopping lists, habitual shopping lists, re-ordering lists, repeat purchasing lists, or any automatic re-ordering requests, and/or shopping habits, or order history or order histories, for or regarding any transactions with the merchant or any other merchants, or any of the user's past transaction shopping carts or transaction receipts, and/or any of the user's saved shopping carts from previous shopping transactions engaged in by the user in a transaction with the merchant or any other merchant, or any other data and/or information regarding the user's interests, purchasing habits, use habits, and/or goods, products, or merchandise, or services, which the user is likely to purchase or browse on-line. In a preferred embodiment, the user, at step 604, can also place an order from or using the user's past transaction shopping cart(s) or transaction receipt(s), and/or any of the user's saved shopping cart(s), or from or using any information contained therein.

In another preferred embodiment, at step 604, the user can also request and be provided with any data and/or information, regarding the user or any other person or individual for whom the user might be shopping and which is described herein as being stored in the database 10H or the database 50H.

At step 604, the user can also select, from the merchant on-line store, the store index page, or any of the merchandise shopping group pages, to receive or obtain and can be provided with, for viewing at any time, any video clips, video recordings, video footage, tutorials, do-it-yourself tutorials, educational or training videos, recipes, or any other data and/or information which the user might find desirable or helpful while shopping for, or using, any goods, products, or items of merchandise. At step 604, while shopping for food, the user can also shop from recipes by selecting from among the items provided in or listed in any recipe ingredient lists.

In another preferred embodiment, at step 604, the user, if or while shopping for any food goods, products, or merchandise, or any other goods, products, or merchandise, can request and can be provided with, for use in or while shopping, any information regarding the user, any of member(s) of the user's family or household, any relative of the user, and/or any individual under the user's care or supervision, any information regarding any medical, dietary, and/or nutritional, needs, or any special needs requirements, food limitations, food restrictions, dietary requirements, dietary limitations, dietary restrictions, allergies, medical needs, medical restrictions, wellness needs, wellness restrictions, fitness needs, and/or fitness restrictions, for or regarding the user and/or each member of the user's family or household, each relative of the user, and/or each individual under the user's care or supervision.

In another preferred embodiment, at step 604, the user, if or while shopping for any food goods, products, or merchandise, or any other goods, products, or merchandise, can request and can be provided with, for use in or while shopping, any information regarding a food, including, but not limited to, the name, description, quantities/sizes available, nutritional content, nutritional information, caloric information, nutritional facts, dietary information, ingredients, percentage of daily requirements, price, expiration date, and/or typical after purchase shelf life at home

In another preferred embodiment, at step 604, the user, if or while shopping for any food goods, products, or merchandise, or any other goods, products, or merchandise, can request and can be provided with, for use in or while shopping, any information regarding any types or kinds of recipes, recipe ingredients, instructions, video recipe tutorials, cooking tutorials, diet regimen tutorials, wellness tutorials, or fitness tutorials or requirements.

In another preferred embodiment, at step 604, the user, if or while shopping for any for clothing or apparel, footwear, accessories, or any other goods, products, or merchandise, can request and can be provided with, for use in or while shopping, any information regarding the user, any of member(s) of the user's family or household, any relative of the user, and/or any individual under the user's care or supervision, and/or any information regarding any information regarding any clothing of apparel, footwear, or accessories, and/or any type(s), kind(s), style(s), or size(s), of same, for or regarding the user and/or each member of the user's family or household, each relative of the user, and/or each individual under the user's care or supervision.

In another preferred embodiment, at step 604, the user, if or while shopping for any good(s), products(s), or merchandise, can request and can be provided with, for use in or while shopping, any information regarding manufacturing date(s), production date(s), manufacturing time(s), production time(s), manufacturing location, production location, manufacturing or production batch number, lot number, and/or any other information, for or regarding any of the goods, products, or merchandise.

In another preferred embodiment, at step 604, the user, if or while shopping for any goods, products, or merchandise, can also request and can be provided with, for use in or while shopping, any information which can be obtained from any social network to which the user belongs or is a member or from any other social networking members or friends of the user, or from any other social networking contacts or connections.

In another preferred embodiment, the user, at step 604, can also establish or schedule an automatic ordering instruction or request for or regarding a future order of or for, or an automatic re-ordering instruction or request for a future re-order of or for, any good(s), product(s), or item(s) of merchandise, with the merchant. In another preferred embodiment, the user, at step 604, can also schedule the making or placing of any orders or re-orders.

In a preferred embodiment, at any time during step 604, the user can terminate his or her shopping experience or event with the merchant by either by selecting to exit the merchant's on-line store, in the case when the user either has no items in his or her shopping cart or electronic shopping cart or desires to same or a later purchase, or the user can select to proceed to the checkout page of the merchant so as to place his or her on-line order or Internet order with the merchant. At any time during step 604, the user can enter into the communication device 50, and can transmit to the central processing computer 10, any information regarding the user's decision to exit the merchant's on-line store without making a purchase, save any contents in the user's shopping cart or electronic shopping cart without making a purchase, or to check-out with the merchant.

At step 605, the central processing computer 10 can determine whether the user has elected to check-out with the merchant. If, at step 605, the central processing computer 10 determines that the user has elected to check-out with the merchant, the operation of the apparatus 100 invention will proceed to step 606.

At step 606, the central processing computer 10 will process any and/or information regarding the user's on-line order or Internet order for check-out by processing any information regarding any and/or all good(s), product(s), or merchandise, present in the user's shopping cart or electronic shopping cart. In a preferred embodiment, at step 606, the central processing computer 10, at and during check-out, can apply any and/or all discounts, rewards, instant rebates, or coupons, or other price reduction information, which exist or which can be applied, to the user's order at check-out.

In a preferred embodiment, at step 606, the central processing computer 10, at and during check-out, can also automatically apply any and/or all discounts, rewards, instant rebates, or coupons, or other price reduction information, which exist or which can be applied, to the user's order at check-out without the need for the user having to enter and/or provide any information regarding same. In this manner, the user can dispense with the need of having to enter any information or codes, membership information or codes, rewards information or codes, instant rebates information or codes, coupon information or codes, promotional information or codes, or any other information or codes, which may be needed to obtain a price reduction of any type or kind.

For example, at step 606, at and during check-out, the central processing computer 10, without the need for the user having to enter or provide any information or code(s), can automatically apply and/or automatically calculate all discounts, member discounts, merchant member discounts, merchant club shopping discounts, merchant reward points, or sale prices, price reductions, or instant rebates, or can automatically apply any coupons, manufacturer coupons, store coupons, merchant coupons, distributor coupons, or any other coupons, stored in the database 1 OH for the merchant, for the distributor of the merchant, or issued for any of the good(s), product(s), or merchandise, present in the user's shopping cart or electronic shopping cart, that exist for and/or which apply to any of the good(s), product(s), or merchandise, present in the user's shopping cart or electronic shopping cart, to the user's order. In this regard, the apparatus 100 and method of the present invention dispenses with the need for the user to have to find, locate, handle, maintain, store, and/or apply, any coupons, manufacturer coupons, store coupons, merchant coupons, distributor coupons, or any other coupons or instant rebates.

At step 606, the central processing computer 10 can also calculate a final order price for the user's order. In a preferred, the final order price can reflect or include all discounts, rewards, member discounts, merchant member discounts, merchant club shopping discounts, merchant reward points, or sale prices, price reductions, or instant rebates, or any coupons, manufacturer coupons, store coupons, merchant coupons, distributor coupons, or any other coupons, and/or any other price reductions.

At step 607, the user can enter information regarding his or her method, manner, or mode, of payment and/or any payment information and/or any payment identifier information into the communication device 50 and can transmit same to the central processing computer 10. At step 607, the central processing computer 10 can receive and process any and/or all information regarding the transaction, payment for the transaction, and/or any information for completing the on-line transaction or the Internet transaction. At step 608, the central processing computer 10 can then generate a transaction confirmation message and transmit same to the communication device 50. At step 608, the central processing computer can also generate a completed order message and can transmit same to the merchant computer 30 for order processing and fulfillment.

At step 609, the central processing computer can store, in the database 10H, any and/or all information described herein regarding the user's shopping event, including, but not limited to, the time, date, and/or duration, of the user's shopping event, the user's selection of the merchant or merchants, store index page(s) provided, selected merchandise group(s), merchandise group shopping page(s) provided, shopping cart(s) or electronic shopping cart(s) and/or any contents of same for the user's shopping event whether or not an order was placed or a transaction was completed, any information processed by the central processing computer 10 during check-out, any information regarding any application of any and/or all discounts, member discounts, merchant member discounts, merchant club shopping discounts, merchant reward points, or sale prices, price reductions, or instant rebates, or any coupons, manufacturer coupons, store coupons, merchant coupons, distributor coupons, or any other coupons, any information regarding final order price, any information regarding the user's method or mode of payment and/or any payment information and/or payment identifier information, or any information regarding and/or including the transaction confirmation message or completed order message.

In a preferred embodiment, any information regarding any and/or all coupons, manufacturer coupons, store coupons, merchant coupons, distributor coupons, or any other coupons or instant rebates, which are offered for or regarding any goods, products, or items of merchandise, offered for sale by, or sold by, the merchant can be stored in the database 10H and can be automatically accessed and automatically applied, by the central processing computer 10 during check-out. In this regard, the apparatus 100 and method of the present invention dispenses with the need for the user to have to find, locate, handle, maintain, store, and/or apply, any coupons, manufacturer coupons, store coupons, merchant coupons, distributor coupons, or any other coupons or instant rebates.

At step 609, if applicable, the central processing computer 10 can also store, in the database 10H, any and/or all information described herein regarding the user's shopping event or any contents of the user's shopping cart or electronic shopping cart when the user elected to exit the merchant's on-line store without making a purchase.

In a preferred embodiment, any and/or all of the data and/or information described herein as being processed by the apparatus 100 and/or the central processing computer 10 in the embodiment of FIGS. 6A and 6B can be stored in the database 10H of the central processing computer 10. In a preferred embodiment, any and/or all of the data and/or information described herein as being processed by the apparatus 100 and/or the central processing computer 10 in the embodiment of FIGS. 6A and 6B can also be transmitted to and stored in the database 50H of the user's communication device 50. In a preferred embodiment, any and/or all of the data and/or information described herein as being processed by the apparatus 100 and/or the central processing computer 10 in the embodiment of FIGS. 6A and 6B can also be transmitted to and stored in the database 30H of the merchant computer 30 of the merchant. In a preferred embodiment, any and/or all of the data and/or information described herein as being processed by the apparatus 100 and/or the central processing computer 10 in the embodiment of FIGS. 6A and 6B can also be transmitted to and stored in the database 40H of the distributor computer 40 of a distributor of the merchant or a distributor of any good, product, or item of merchandise, added to the user's shopping cart or electronic shopping cart, or purchased by the user, in and/or during the shopping event. Thereafter, the operation of the apparatus 100 will cease at step 610.

If, at step 605, the central processing computer 10 determines that the user has elected to exit the merchant's on-line store without making a purchase, or that the user has elected to save any contents in the user's shopping cart or electronic shopping cart without making a purchase, then the operation of the apparatus 100 will proceed to step 609, and any and/or all of the information described as being stored by the central processing computer 10 at step 609, which is or which may be pertinent to the user's non-purchasing shopping event, and/or any and/or all information described herein regarding the user's shopping event or any contents of the user's shopping cart or electronic shopping cart at the time the user elected to exit the merchant's on-line store without making a purchase, can be stored in the database 10H of the central processing computer 10. Thereafter, the operation of the apparatus 100 will cease at step 610.

In a preferred embodiment, any and/or all of the data and/or information described herein as being processed by the apparatus 100 and/or the central processing computer 10 in the embodiment of FIGS. 6A and 6B can be stored in the database 10H of the central processing computer 10. In a preferred embodiment, any and/or all of the data and/or information described herein as being processed by the apparatus 100 and/or the central processing computer 10 in the embodiment of FIGS. 6A and 6B can also be transmitted to and stored in the database 50H of the user's communication device 50. In a preferred embodiment, any and/or all of the data and/or information described herein as being processed by the apparatus 100 and/or the central processing computer 10 in the embodiment of FIGS. 6A and 6B can also be transmitted to and stored in the database 30H of the merchant computer 30 of the merchant. In a preferred embodiment, any and/or all of the data and/or information described herein as being processed by the apparatus 100 and/or the central processing computer 10 in the embodiment of FIGS. 6A and 6B can also be transmitted to and stored in the database 40H of the distributor computer 40 of a distributor of the merchant or a distributor of any good, product, or item of merchandise, added to the user's shopping cart or electronic shopping cart, or purchased by the user, in and/or during the shopping event.

In a preferred embodiment, and/or in any and/or all of the embodiments described herein, the central processing computer 10 can be programmed to automatically transmit any updates to or of any data and/or information stored in the database 10H, which may be common to data and/or information stored in a database 30H of a merchant computer 30 of a respective merchant, in a database 40H of a distributor computer 40, or in a database 50H of a communication device 50, to that merchant computer 30, that distributor computer 40, or to that communication device 50, which merchant computer 30, distributor computer 40, or communication device 50, can be programmed to automatically receive the updates and update its respective database 30H, 40H, or 50H accordingly. Similarly, in a preferred embodiment, each merchant computer 30, distributor computer 40, and communication device 50, utilized in connection with the apparatus 100 can also be programmed to transmit any updates in their respective databases 30H, 40H, or 50H, to the central processing computer 10 which can also be programmed to automatically receive the updates and update its respective database 10H, as well as re-transmit any updates to any other merchant computers 30, distributor computers 40, or communication devices 50.

In another preferred embodiment, the embodiment of FIGS. 6A and 6B can be utilized in connection with on-line shopping and/or Internet shopping for or involving any good(s), product(s), or merchandise, or any service(s), which can be offered for sale by, or sold by, any of the various types or kinds of merchants and/or distributors described herein, and/or in connection with on-line shopping and/or Internet shopping for or involving any good(s), product(s), or merchandise, or any service(s), which can be the subject of commerce.

In another preferred embodiment, the embodiment of FIGS. 6A and 6B can be utilized by a user in order to shop on-line and/or via the Internet with two or more merchants in or during a single shopping event. In this regard, if a user typically likes to purchase certain goods, products, or merchandise from a merchant and certain other goods, products, or merchandise from a merchant, the central processing computer 10 can provide the user with each merchant's on-line store, and/or for each merchant's on-line store, any of the respective merchant's store index pages, the respective merchant's merchandise shopping group pages and any/or all information, pictures, photographs, video, or video images, described herein as being included or provided in or with same, and/or the user's shopping cart or electronic shopping cart with the respective merchant, in either a split screen format, a multi-screen format, an alternating screen format, alternating and/or screen minimization format, and/or any other appropriate format for allowing of facilitating on-line and/or Internet shopping with multiple merchants in or during a single shopping event or a same shopping event.

In this regard, in a preferred embodiment, the central processing computer 10 can perform any and/or all of the functions and/or functionality, described herein as being performed by the central processing computer 10 in the method of FIGS. 6A and 6B in order to allow of facilitate a user being able to shop one-line and/or via the Internet with more than one merchant in and/or during a single shopping event or a same shopping event.

In another preferred embodiment, the apparatus 100 and method of FIGS. 6A and 6B can also be utilized in a same, a similar, and/or an analogous, manner in order to facilitate or to allow a user to shop on-line and/or via the Internet with any of the herein-described distributors in the distributor's brick and mortar store and/or with the distributor's on-line store.

In another preferred embodiment, as well as any and/or all of the embodiments described herein, a user can access the merchant computer 30 of or associated with any of the herein-described merchants either directly via a communication network and/or via the central processing computer 10 and can engage in on-line shopping and/or Internet shopping directly with the merchant computer 30 in a same, a similar, and/or an analogous, manner as described in the preferred embodiment of FIGS. 6A and 6B.

In another preferred embodiment, as well as any and/or all of the embodiments described herein, a user can access the distributor computer 30 of or associated with any of the herein-described distributors either directly via a communication network and/or via the central processing computer 10 and can engage in on-line shopping and/or Internet shopping directly with the distributor computer 30 in a same, a similar, and/or an analogous, manner as described in the preferred embodiment of FIGS. 6A and 6B.

In another preferred embodiment of the embodiment of FIGS. 6A and 6B, as well as any and/or all of the embodiments described herein, the apparatus 100 of the present invention can be utilized by any of the herein-described merchants to provide “store within a store” shopping. In a preferred embodiment, the merchant can have a physical location of its brick and mortar store dedicated to displaying goods, products, or merchandise, of or from a single brand or a single manufacturer, such as, for example, but not limited to, an electronics manufacturer, a clothing designer, a specialty food producer, or any other brand or brand provider. In a preferred embodiment, the merchant can provide on-line shopping and/or Internet shopping for its brick and mortar store “store within a store” offerings by utilizing one of more merchandise group shopping page(s) dedicated to the goods, products, or merchandise, of a single brand or a single manufacturer.

For example, if a merchant consumer electronics store provides a section of its brick and mortar store for selling computers, tablets, cellular telephones, and any other goods, products, or merchandise a single brand name, one or more merchandise shopping group pages can be utilized in order to facilitate on-line shopping and/or Internet shopping regarding same. In a same, a similar, or an analogous, manner, designer fashion label clothing, footwear, accessories, and/or any other goods, products, or merchandise, can also be offered by a department store or a fashion boutique by utilizing one or more merchandise shopping group pages for that designer label or designer brand.

In another preferred embodiment, the apparatus 100 and method of the present invention can be utilized in a same, a similar, and/or an analogous, manner as the method of FIGS. 6A and 6B, in connection with or in conjunction with any infomercial and/or any live or pre-recorded video presentation of a good(s), product(s), or item(s) of merchandise, an introduction of a good(s), product(s), or item(s) of merchandise, a show, or a fashion show, or any other activity (hereinafter “video presentation”), which can be utilized to showcase and/or offer for same, any good(s), product(s), or item(s) of merchandise. In such an embodiment, the video presentation, along with any information regarding any good(s) product(s), or item(s) of merchandise, featured therein or thereby, can be provided via a merchant shopping group page associated with any merchant or merchants, or any distributor or distributors who or which offer the video presentation and/or who or which sponsor same.

In another preferred embodiment, the apparatus 100 and method of the present invention can be utilized in order to provide electronic coupon accounts for any of the merchants, distributors, and users, described herein, and/or for any operator(s) of any of the herein-described central processing computers 10. In a preferred embodiment, an electronic coupon account for or associated with a merchant can be stored in the database 30H of the merchant's merchant computer 30 and can contain any and/or all electronic coupons or instant rebates, and/or any data and/or information regarding or corresponding to any coupons, electronic coupons, or instant rebates and/or any digital or electronic representations of same. In a preferred embodiment, any of the electronic coupons or instant rebates, and/or any data and/or information regarding or corresponding to any coupons, electronic coupons, or instant rebates, and/or any digital or electronic representations of same, can be generated by the merchant computer 30 at any time and/or can be generated by any distributor computer 40 at any time and/or can be transmitted from the distributor computer 40 or any other distributor computer 40 to the merchant computer 40 at any time for inclusion in the merchant's electronic coupon account. In a preferred embodiment, the merchant's electronic coupon account can contain or include electronic coupons or instant rebates, or any digital or electronic representations of same, from any of the herein-described distributors.

In another preferred embodiment, an electronic coupon account for or associated with a distributor can be stored in the database 40H of the distributor's computer 40 and can contain any and/or all electronic coupons or instant rebates, and/or any data and/or information regarding or corresponding to any coupons, electronic coupons, or instant rebates and/or any digital or electronic representations of same. In a preferred embodiment, any of the electronic coupons or instant rebates, and/or any data and/or information regarding or corresponding to any coupons, electronic coupons, or instant rebates, and/or any digital or electronic representations of same, can be generated by the distributor computer 40 at any time and/or can be generated by any other distributor computer 40 at any time and/or can be transmitted from that coupon generating distributor computer 40 to the distributor computer 40 at any time for inclusion in the distributor's electronic coupon account. In a preferred embodiment, the distributor's electronic coupon account can contain or include electronic coupons or instant rebates, or any digital or electronic representations of same, from any of the herein-described distributors.

In another preferred embodiment, an electronic coupon account for or associated with a user can be stored in the database 50H of the user's computer 50 and can contain any and/or all electronic coupons or instant rebates, and/or any data and/or information regarding or corresponding to any coupons, electronic coupons, or instant rebates and/or any digital or electronic representations of same. In a preferred embodiment, any of the electronic coupons or instant rebates, and/or any data and/or information regarding or corresponding to any coupons, electronic coupons, or instant rebates, and/or any digital or electronic representations of same, can be generated by any of the herein-described merchant computers 30 and/or distributor computers 40 at any time and/or can be transmitted from the respective merchant computer 30 or distributor computer 40 to the user's communication device 50 at any time for inclusion in the user's electronic coupon account. In a preferred embodiment, the user's electronic coupon account can contain or include electronic coupons or instant rebates, or any digital or electronic representations of same, from any of the herein-described merchants or distributors.

In another preferred embodiment, the apparatus 100 and method of the present invention can be utilized to automatically create or establish an account or a relationship or any type or kind of marketing relationship and/or direct marketing relationship between any user and any of the herein-described distributors of and/or to any of the herein-described merchants. In a preferred embodiment, the central processing computer 10 can process information for creating or establishing an account or a relationship between a user and a distributor any time a user browses, places in his or her shopping cart or electronic shopping cart, or purchases, any good(s), product(s), or merchandise, of or provided by the distributor.

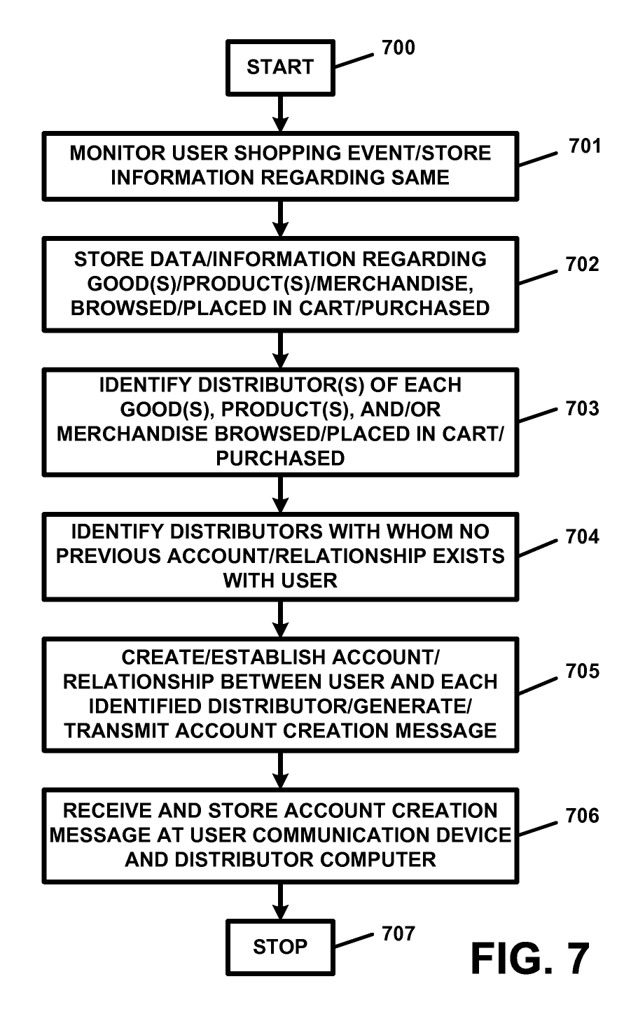

FIG. 7 illustrates another preferred embodiment method for utilizing the apparatus 100 of the present invention, in flow diagram form. With reference to FIG. 7, the operation of the apparatus commences at step 700. At step 701, the central processing computer 10, in a preferred embodiment, monitors a user's shopping event from start to finish and stores any and/or all data and/or information regarding any good(s), product(s), or item(s) of merchandise, browsed by the user, placed in a shopping cart or an electronic shopping cart of the user, or purchased by the user. At step 702, after the user terminates the shopping event, the central processing computer 10 stores any data and/or information regarding any good(s), product(s), or item(s) of merchandise, browsed by the user, placed in a shopping cart or an electronic shopping cart of the user, or purchased by the user, in the database 10H.

At step 703, the central processing computer 10 will, for each good(s), product(s), or item(s) of merchandise, browsed by the user, placed in a shopping cart or an electronic shopping cart of the user, or purchased by the user, identify the distributor or distributors of same and store any and/or all information regarding the good(s), product(s), or item(s) of merchandise, along with the identified distributor or distributors of same. Once the central processing computer 10 completes identifying the distributor or distributors for all of the good(s), product(s), or item(s) of merchandise, browsed by the user, placed in a shopping cart or an electronic shopping cart of the user, or purchased by the user, in or during the shopping event, the any and/or all data and/or information relating thereto is stored in the database 10H, the operation of the apparatus 100 will proceed to step 704.

At step 704, the central processing computer 10 will identify, using previously stored information regarding any of the user's pre-existing accounts or relationships with any distributor(s), the distributor or distributors with whom the user does not have an existing account or relationship. At step 705, for each distributor which the central processing computer 10 identifies, at step 704, as not having an existing account or relationship with the user, the central processing computer 10 will process any needed or desired information for creating or establishing an account or a relationship between the user and the distributor.

At step 705, the central processing computer 10 will, for each identified distributor, generate an account creation message, evidencing the creation of the account or relationship between the user and the distributor, containing or including information regarding the user, including, but not limited to, the user's name, address, telephone number, e-mail address, text message number, SMS number, and/or any information regarding any good(s), product(s), or item(s) of merchandise, of the distributor which was browsed by the user, placed in a shopping cart or an electronic shopping cart of the user, or purchased by the user, and/or any other information described herein as being stored in any of the databases 10H, 30H, 40H, or 50H, for or regarding the user. The account creation message can also contain or include any information regarding the distributor, including but not limited to, the distributor's name, address, telephone number, website, e-mail address, text message number, SMS number, information regarding goods, products, or items of merchandise, provided by the distributor, and/or any link(s) or hyperlink(s) to same, and/or any other information regarding the distributor.

At step 705, the central processing computer 10 can, for each account creation message generated, transmit the account creation message to the communication device 50 of or associated with the user and to the respective distributor computer 40 of or associated with the respective distributor. At step 706, the user communication device 50, for each account creation message generated and transmitted to same, will receive and store the respective account creation message in the database 50H. At step 706, each respective distributor computer 40 to which an account creation message is transmitted can receive and store the respective account creation message in the database 40H.

Once the account or relationship has been established and the distributor has the user's contact information, the distributor can, pursuant to the established relationship, transmit information, marketing information and/or materials, promotional information and/or materials, sale and/or clearance information and/or materials, electronic coupons or information regarding same, instant rebates or information regarding same, and/or any other information, directly to the user's communication device 50 and/or the distributor can engage in any marketing or direct marketing activities with the user. Once the account or relationship has been established and the user has the distributor's contact information, the user can, pursuant to the established account or relationship, request information, marketing information and/or materials, promotional information and/or materials, sale and/or clearance information and/or materials, electronic coupons or information regarding same, instant rebates or information regarding same, and/or any other information, directly from the distributor by using the user's communication device 50 to communication with the distributor's computer 40.

In a preferred embodiment, any of the above-described information and/or materials, which are transmitted to the user communication device 50, can also be transmitted to, and stored at, the central processing computer 10 and/or in the database 10H of same, and/or in the user's account data and/or information in the database 10H, for later use and/or retrieval by the user. Thereafter, the operation of the apparatus 100 will cease at step 707. In a preferred embodiment, any and/or all account creation messages generated by the central processing computer 10 can also be stored in the database 10H of same.

In a preferred embodiment, any user of the apparatus 100 of the present invention can request to receive any of the herein-described alerts, alert messages, notifications, notification messages, coupon alerts, sales alerts, availability alerts, delivery alerts, order alerts, reorder alerts, new products alerts, and/or new services alerts, and/or any other alerts or notifications, from the central processing computer(s) 10 and/or from any of the herein-described merchant computer(s) 30 and/or distributor computers 40. In a preferred embodiment, any user can utilize his or her communication device 50 in order to access the central processing computer 10 and to transmit his or her request to receive any of the herein-described alerts, alert messages, notifications, notification messages, coupon alerts, sales alerts, availability alerts, delivery alerts, order alerts, reorder alerts, new products alerts, and/or new services alerts, and/or any other alerts or notifications, from the central processing computer 10, from any merchant computer 30, or from any distributor computer 40. The central processing computer 10 can receive and process the user's request and store any information regarding same in the database 10H. The central processing computer 10 can also transmit any request to any respective merchant computer 30 or distributor computer 40 which can store information regarding same in the respective database 30H or 40H of same.

In another preferred embodiment, any user can utilize his or her communication device 50 in order to access a merchant computer 30 or a distributor computer 40 and to transmit his or her request to receive any of the herein-described alerts, alert messages, notifications, notification messages, coupon alerts, sales alerts, availability alerts, delivery alerts, order alerts, reorder alerts, new products alerts, and/or new services alerts, and/or any other alerts or notifications, from the respective merchant computer 30 or distributor computer 40. The respective merchant computer 30 or distributor computer 40 can receive and process the user's request and store any information regarding same in its respective database 30H or 40H.

In a preferred embodiment, any of the various herein-described alerts, alert messages, notifications, notification messages, coupon alerts, sales alerts, availability alerts, delivery alerts, order alerts, reorder alerts, new products alerts, and/or new services alerts, and/or any other alerts or notifications, can be transmitted as, in, or as an attachment to, an e-mail message, a text message, pre-recorded telephone message, or via any other type, kind, or mode of communication.

In another preferred embodiment, as well as any and/or all of the embodiments described herein, any of the central processing computer(s) 10, the merchant computer (s) 30, the distributor computer(s) 40, and the communication device(s) 50, can be programmed to translate any text information or audio information from one language into another language. In a preferred embodiment, a user, when establishing a shopping account with any merchant or distributor, or when establishing an account with the apparatus 100 or the central processing computer 10, can provide information regarding, or can specify, any language or languages in which the user desires to receive any of the text information or audio information, or other information, which the user might desire to obtain or be provided with when using the apparatus 100 of the present invention, or the language or languages in which the user desires to utilize the apparatus 100 of the present invention.

In another preferred embodiment, as well as any and/or all of the embodiments described herein, any of the merchant computers 30, the distributor computers 40, and/or the communication devices 50, described herein can perform any and/or all of the various processing routines, functions, and/or functionality, which is described herein as being provided by the central processing computer 10. For example, in another preferred embodiment, a user can directly access a merchant computer 30 or a distributor computer 40 and engage in on shopping or Internet shopping with same. In such and instance the respective merchant computer 30 or distributor computer 40 can perform all processing routines, functions, and/or functionality, described herein as being provided by the central processing computer 10 in the preferred embodiment of FIGS. 6A and 6B. In such an embodiment, the need to transmit an order message or a completed order message can be dispensed with.

As and for another example, a user can also engage in a shopping event with and using only his or her communication device 50, and any and/or all of the data and/or information described herein as being stored in any of the databases 10H, 30H, 40H, and/or 50H, with any of said data and/or information from the databases 10H, 30H, and/or 40H having been previously transmitted to and/or stored in the database 50H of the communication device 50. When the shopping event is complete, the user can access the respective merchant computer 30 or distributor computer 40 via the communication network and/or the Internet and can transmit an order message or a completed order message to same.

In any and/or all of the embodiments described herein, the central processing computer(s) 10 can be programmed in order to automatically, and/or without user intervention, perform any and/or all of the processing routines, functions, and/or functionality described herein as being performed by same. In any and/or all of the embodiments described herein, each of the merchant computer(s) 30, the distributor computer(s) 40, and/or the communication device(s) 50, can be programmed in order to automatically, and/or without user intervention, perform any and/or all of the respective processing routines, functions, and/or functionality described herein as being performed by same.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A computer-implemented method, comprising:
receiving, with a receiver, a processing device, or a computer, a request from a user for information regarding a selected merchandise group for or regarding any type or kind of a good, a product, or an item of merchandise, offered for sale by a merchant in a brick and mortar store of or associated with the merchant;
processing information regarding the request, with or using the processing device or the computer; and
transmitting, from a transmitter, the processing device, or the computer, a merchandise group shopping page to a communication device of, associated with, or used by, the user in response to the request, wherein the merchandise group shopping page contains at least one photograph, at least one picture, at least one video, or at least one video image, of the merchant's brick and mortar store offering, assortment, or arrangement, of goods, products, or items of merchandise, in the selected merchandise group.

2. The computer-implemented method of claim 1, wherein the at least one photograph, the at least one picture, the at least one video, or the at least one video image, shows at least one good, at least one product, or at least one item of merchandise, in an aisle, on a store shelf, rack, display stand, or display rack, or on or in a showcase, wall display, or point-of-sale display, in the merchant's brick and mortar store.

3. The computer-implemented method of claim 1, wherein the merchandise shopping group page also contains information regarding or identifying each of any number of different brands, types, or kinds, of goods, products, or items of merchandise, shown in the at least one photograph, the at least one picture, the at least one video, or the at least one video image.

4. The computer-implemented method of claim 1, wherein the merchandise shopping group page also contains information regarding information or a link or hyperlink to information or a description of or regarding a good, a product, or an item of merchandise, shown in the at least one photograph, the at least one picture, the at least one video, or the at least one video image.

5. The computer-implemented method of claim 1, wherein the merchandise shopping group page also contains information regarding a price, a sale, a promotion, or a clearance, a coupon, an instant rebate, or a rebate, of, for, or regarding, a good, a product, or an item of merchandise, shown in the at least one photograph, the at least one picture, the at least one video, or the at least one video image.

6. The computer-implemented method of claim 1, further comprising:
receiving and storing information regarding a good, a product, or an item of merchandise, added to a shopping cart or an electronic shopping cart of or for the user in or during a shopping event with the merchant.

7. The computer-implemented method of claim 6, further comprising
processing, with or using the processing device or with or using the computer, information regarding a transaction between the user and the merchant for effectuating a check-out or a completion for or regarding the shopping event with the merchant.

8. The computer-implemented method of claim 7, further comprising:
processing, with or using the processing device or the computer, information for automatically applying a coupon, a rebate, an instant rebate, a sale price, or a price reduction, for or regarding at least one good, at least one product, or at least one item of merchandise, contained in the shopping cart or the electronic shopping cart.

9. The computer-implemented method of claim 1, further comprising:
processing, with or using the processing device or the computer, information for identifying a distributor associated with a good, a product, or an item of merchandise, added to a shopping cart or an electronic shopping cart of or for the user in or during a shopping event with the merchant.

10. The computer-implemented method of claim 9, further comprising:
determining with or using the processing device or the computer, that no account or relationship exists with or between the user and the distributor; and
processing, with or using the processing device or the computer, information for creating or establishing an account or a relationship with or between the user and the merchant.

11. The computer-implemented method of claim 1, further comprising:
storing, in a memory device associated with the processing device or the computer, information regarding coupons for the user.

12. The computer-implemented method of claim 1, where the processing device or the computer is associated with a plurality of merchants or a plurality of distributors.

13. The computer-implemented method of claim 1, where the processing device or the computer is associated with a single merchant or a single distributor.

14. The computer-implemented method of claim 1, wherein the communication device is a personal computer, a notebook computer, or a laptop computer.

15. The computer-implemented method of claim 1, wherein the communication device is a tablet or tablet computer.

16. The computer-implemented method of claim 1, wherein the communication device is a cellular telephone, a Smartphone, or a personal digital assistant.

17. The computer-implemented method of claim 1, wherein the processing device or the computer is used by or associated with a merchant or a distributor.

18. A computer-implemented method, comprising:
storing, in a memory device or in a database, information regarding a merchandise group shopping page for each selected merchandise group of any number of selected merchandise groups of any goods, products, or merchandise, offered for sale by a merchant in a brick and mortar store of or associated with the merchant, wherein each merchandise shopping group page associated with a selected merchandise group contains at least one photograph, at least one picture, at least one video, or at least one video image, of the merchant's brick and mortar store offering, assortment, or arrangement, of goods, products, or items of merchandise, in the selected merchandise group;
processing, with a processing device or with a computer associated with a communication device, information regarding a request by a user for information regarding a selected merchandise group for or regarding any type or kind of a good, a product, or an item of merchandise, offered for sale by a merchant in the brick and mortar store of or associated with the merchant; and
displaying, on or with a display device of or associated with the communication device, a merchandise group shopping page in response to the request, wherein the merchandise group shopping page contains at least one photograph, at least one picture, at least one video, or at least one video image, of the merchant's brick and mortar store offering, assortment, or arrangement, of goods, products, or items of merchandise, in the selected merchandise group,
wherein the communication device is a cellular telephone, a Smartphone, or a personal digital assistant.

19. An apparatus, comprising:
a receiver, wherein the receiver receives a request from a user for information regarding a selected merchandise group for or regarding any type or kind of a good, a product, or an item of merchandise, offered for sale by a merchant in a brick and mortar store of or associated with the merchant;
a processor, wherein the processor processes information regarding the request; and
a transmitter, wherein the transmitter transmits a merchandise group shopping page to a communication device of, associated with, or used by, the user in response to the request, wherein the merchandise group shopping page contains at least one photograph, at least one picture, at least one video, or at least one video image, of the merchant's brick and mortar store offering, assortment, or arrangement, of goods, products, or items of merchandise, in the selected merchandise group.

20. The apparatus of claim 19, wherein the apparatus receives and stores information regarding a good, a product, or an item of merchandise, added to a shopping cart or an electronic shopping cart of or for the user in or during a shopping event with the merchant, and further wherein the apparatus processes information regarding a transaction between the user and the merchant for effectuating a check-out or a completion for or regarding the shopping event with the merchant.
